(19) United States
(12) Patent Application Publication
(10) Pub. No.: US 2026/0087289 A1
(43) Pub. Date: Mar. 26, 2026

(54) IMAGE PROCESSING APPARATUS AND IMAGE PROCESSING METHOD

(71) Applicant: CANON KABUSHIKI KAISHA, Tokyo (JP)

(72) Inventors: FUMIKO SUZUKI, Tokyo (JP); DAISUKE KOBAYASHI, Kanagawa (JP)

(21) Appl. No.: 19/340,120

(22) Filed: Sep. 25, 2025

(30) Foreign Application Priority Data
Sep. 26, 2024 (JP) 2024-167827
Jun. 18, 2025 (JP) 2025-102663

(51) Int. Cl. G06K 15/02

(52) U.S. Cl. CPC G06K 15/02

(57) ABSTRACT

An image processing apparatus comprises a printing unit configured to downsample and print a two-dimensional code image when a mode for two-dimensional code image printing different from a mode for text printing is set.

### BACKGROUND

### Field of the Technology

The present disclosure relates to printing technology.

### Description of the Related Art

A known technology (hereinafter referred to as edge processing) includes changing a printing processing for an edge of an image for printing a printed material that tends to cause scanning errors such as a QR code (registered trademark) and similar two-dimensional codes and the like. Japanese Patent Laid-Open No. 2008-183778 describes technology in which a region that functions as a retarding basin is provided by reducing the ink amount on the inner side of the edge pixel of the code image for reducing a decrease in the scanning accuracy due to ink forming black cells on a code image bleeding outside off the black cells.

However, if edge processing specialized for enhancing the scanning accuracy of a code image is also applied to text, the line width of the text may be too small, which may lead to a decrease in readability.

### SUMMARY

The present disclosure provides technology enabling printing of a two-dimensional code image taking into account scanning accuracy and without affecting printing of text.

According to the first aspect of the present disclosure, there is provided an image processing apparatus comprising: a printing unit configured to downsample and print a two-dimensional code image when a mode for two-dimensional code image printing different from a mode for text printing is set.

According to the second aspect of the present disclosure, there is provided an image processing method performed by an image processing apparatus comprising: downsampling and printing a two-dimensional code image when a mode for two-dimensional code image printing different from a mode for text printing is set.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a perspective view illustrating an overview of a printing unit in a printing apparatus 2.

FIG. 2A is a diagram illustrating an example configuration of a printing system.

FIG. 2B is a block diagram of an example of the hardware configuration of an image processing apparatus 100.

FIG. 3A is a flowchart of edge detection and image printing.

FIG. 3B is a flowchart illustrating in detail the processing of step S303.

FIG. 3C is a flowchart of dot position adjustment using discharge position adjustment values.

FIG. 4A is a diagram for describing edge pattern detection.

FIG. 4B is a diagram for describing edge pattern detection.

FIG. 4C is a diagram for describing edge pattern detection.

FIG. 5 is a diagram for describing pattern matching.

FIG. 6 is a flowchart of color separation quantization processing executed in step S304.

FIG. 7A is a flowchart of nozzle separation processing executed in step S305.

FIG. 7B is a diagram illustrating a setting example of first tone correction processing.

FIG. 7C is a diagram illustrating a setting example of first tone correction processing.

FIG. 8A is a diagram illustrating an example of a dot arrangement pattern and a reference index pattern.

FIG. 8B is a diagram illustrating an example of a dot arrangement pattern and a reference index pattern.

FIG. 8C is a diagram illustrating an example of a dot arrangement pattern and a reference index pattern.

FIG. 8D is a diagram illustrating an example of a dot arrangement pattern and a reference index pattern.

FIG. 9A is a schematic view of a print head H as seen from the upper surface of the printing apparatus 2.

FIG. 9B is a schematic view of the print head H as seen from the upper surface of the printing apparatus 2.

FIG. 9C is a schematic view of the print head H as seen from the upper surface of the printing apparatus 2.

FIG. 10A-a is a diagram for describing data relating to each process executed by an image processing unit 208.

FIG. 10A-b is a diagram for describing data relating to each process executed by the image processing unit 208.

FIG. 10A-c is a diagram for describing data relating to each process executed by the image processing unit 208.

FIG. 10A-d is a diagram for describing data relating to each process executed by the image processing unit 208.

FIG. 10A-e is a diagram for describing data relating to each process executed by the image processing unit 208.

FIG. 10B-a is a diagram for describing data relating to each process executed by the image processing unit 208.

FIG. 10B-b is a diagram for describing data relating to each process executed by the image processing unit 208.

FIG. 11A is a diagram for describing data relating to each process executed by the image processing unit 208.

FIG. 11B is a diagram for describing data relating to each process executed by the image processing unit 208.

FIG. 11C is a diagram for describing data relating to each process executed by the image processing unit 208.

FIG. 11D is a diagram for describing data relating to each process executed by the image processing unit 208.

FIG. 11E is a diagram for describing data relating to each process executed by the image processing unit 208.

FIG. 12A is a flowchart of color separation quantization processing executed in step S304 for cyan, magenta, and yellow.

FIG. 12B is a flowchart illustrating in detail nozzle separation processing executed in step S305.

FIG. 12C is a diagram illustrating an example of a dot arrangement pattern used in index expansion processing.

FIG. 12D is a diagram illustrating an example of a dot arrangement pattern used in index expansion processing.

FIG. 13A is a flowchart illustrating in detail the color separation quantization processing executed in step S304.

FIG. 13B is a diagram illustrating a setting example of second tone correction processing.

FIG. 14A-a is a diagram for describing data relating to each process executed by the image processing unit 208.

FIG. 14A-b is a diagram for describing data relating to each process executed by the image processing unit 208.

FIG. 14A-c is a diagram for describing data relating to each process executed by the image processing unit 208.

FIG. 14A-d is a diagram for describing data relating to each process executed by the image processing unit 208.

FIG. 14A-e is a diagram for describing data relating to each process executed by the image processing unit 208.

FIG. 14B-a is a diagram for describing data relating to each process executed by the image processing unit 208.

FIG. 14B-b is a diagram for describing data relating to each process executed by the image processing unit 208.

FIG. 15A is a diagram for describing data relating to each process executed by the image processing unit 208.

FIG. 15B is a diagram for describing data relating to each process executed by the image processing unit 208.

FIG. 15C is a diagram for describing data relating to each process executed by the image processing unit 208.

FIG. 15D is a diagram for describing data relating to each process executed by the image processing unit 208.

FIG. 15E is a diagram for describing data relating to each process executed by the image processing unit 208.

FIG. 16A-a is a diagram for describing data relating to each process executed by the image processing unit 208.

FIG. 16A-b is a diagram for describing data relating to each process executed by the image processing unit 208.

FIG. 16A-c is a diagram for describing data relating to each process executed by the image processing unit 208.

FIG. 16A-d is a diagram for describing data relating to each process executed by the image processing unit 208.

FIG. 16A-e is a diagram for describing data relating to each process executed by the image processing unit 208.

FIG. 16A-f is a diagram for describing data relating to each process executed by the image processing unit 208.

FIG. 16B is a diagram for describing data relating to each process executed by the image processing unit 208.

FIG. 17 is a diagram for describing the second tone correction processing.

FIG. 18A-a is a diagram for describing data relating to each process executed by the image processing unit 208.

FIG. 18A-b is a diagram for describing data relating to each process executed by the image processing unit 208.

FIG. 18A-c is a diagram for describing data relating to each process executed by the image processing unit 208.

FIG. 18A-d is a diagram for describing data relating to each process executed by the image processing unit 208.

FIG. 18A-e is a diagram for describing data relating to each process executed by the image processing unit 208.

FIG. 18B-a is a diagram for describing data relating to each process executed by the image processing unit 208.

FIG. 18B-b is a diagram for describing data relating to each process executed by the image processing unit 208.

FIG. 18B-c is a diagram for describing data relating to each process executed by the image processing unit 208.

FIG. 19A-a is a diagram for describing discharge position adjustment.

FIG. 19A-b is a diagram for describing discharge position adjustment.

FIG. 19A-c is a diagram for describing discharge position adjustment.

FIG. 19A-d is a diagram for describing discharge position adjustment.

FIG. 19B-a is a diagram for describing discharge position adjustment.

FIG. 19B-b is a diagram for describing discharge position adjustment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Printing Apparatus Structure

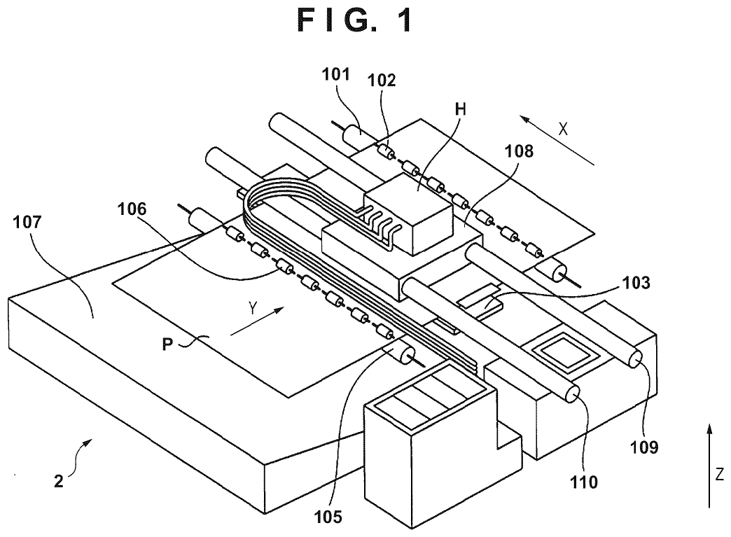

First, the main structure of a printing apparatus according to each embodiment will be described below using FIG. 1. FIG. 1 is a perspective view illustrating an overview of a printing unit in a printing apparatus 2. A print medium P such as paper feed to the printing unit is conveyed by a nip portion of a conveyance roller 101 disposed on a conveyance path of the print medium P and a pinch roller 102 driven thereby in a-Y direction (sub-scan direction) in accordance with the rotation of the conveyance roller 101. A platen 103 is provided at a print position opposite a surface (nozzle surface) where a nozzle of a print head H of an inkjet printing system is formed and supports the back surface of the print medium P from below. In this manner, a certain distance is maintained between the front surface of the print medium P and the nozzle surface of the print head H. The print medium P printed with an image on the platen 103 is nipped between a discharge roller 105 and spurs 106 driven thereby and conveyed in the −Y direction in accordance with the rotation of a discharge roller 105 and discharged to a discharge tray 107.

The print head H is detachably installed in a carriage 108 in a position with the nozzle surface facing the platen 103 or the print medium P. The carriage 108 moves back and forth in an X direction along two guide rails 109 and 110 via a driving force from a carriage motor (not illustrated), and via this movement process, the print head H performs a discharge operation according to a discharge signal. The ±X direction in which the carriage 108 moves is a direction orthogonal to the −Y direction in which the print medium P is conveyed and is referred to as a main scan direction. The −Y direction in which the print medium P is conveyed is referred to as the sub-scan direction. By alternately repeating a main scan (movement with discharge) of the carriage 108 and the print head H and conveyance (sub-scan) of the print medium P, an image is incrementally formed on the print medium P. Hereinafter, the main scan in the +X direction of the print head H is referred to as a forward scan, and the main scan in the −X direction is referred to as a backward scan.

### Print Head H Structure

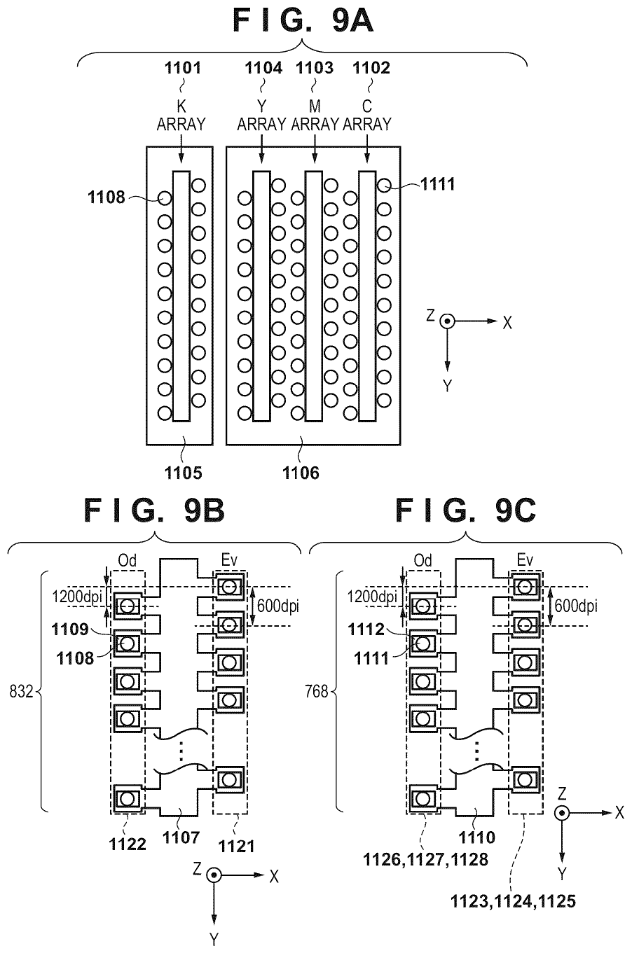

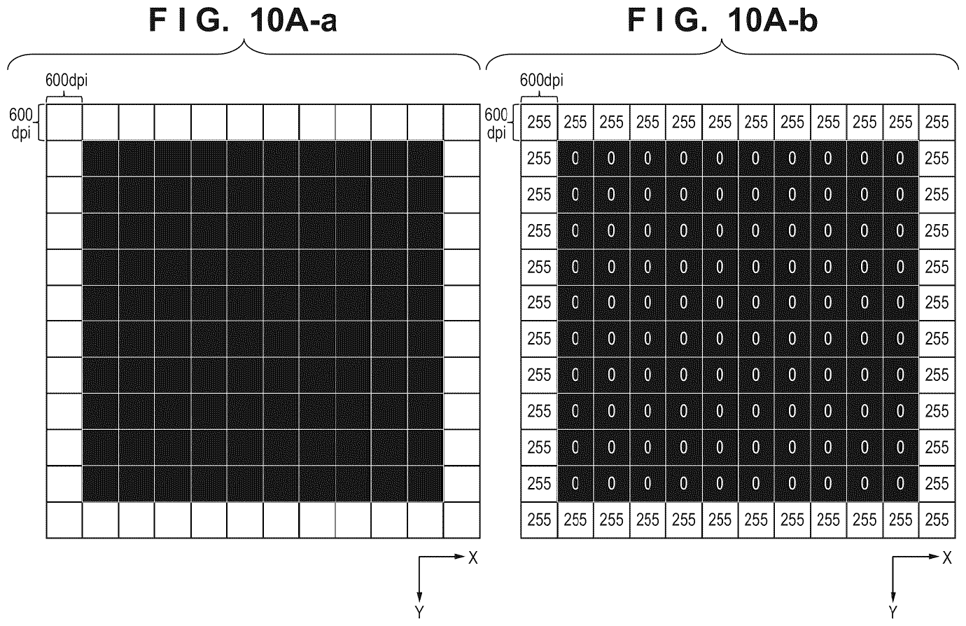

Next, the structure of the print head H according to each embodiment will be described below using FIGS. 9A to 9C. FIGS. 9A to 9C are schematic views of the print head H as seen from the upper surface of the printing apparatus 2. The print head H includes print chips 1105 and 1106 and receives a print signal from the main body of the printing apparatus 2 via each contact pad (not illustrated) and is supplied with the power required for driving the print head H. As illustrated in FIG. 9A, in the print chip 1105, a nozzle array (K array) 1101 (hereinafter also referred to as a black nozzle array) is disposed that includes a plurality of nozzles arranged in the Y direction for discharging black ink. In the print chip 1106, a nozzle array (C array) 1102 including a plurality of nozzles arranged in the Y direction for discharging cyan ink, a nozzle array (M array) 1103 including a plurality of nozzles arranged in the Y direction for discharging magenta ink, and a nozzle array (Y array) 1104 including a plurality of nozzles arranged in the Y direction for discharging yellow ink are disposed.

FIG. 9B is an enlarged view of the nozzle array 1101. FIG. 9C is an enlarged view of one nozzle array from among the nozzle arrays 1102, 1103, and 1104. The enlarged view is the same for the color ink. Nozzles 1108 and 1111 that discharge ink are disposed on either side of respective ink liquid chambers 1107 and 1110, and discharge heaters 1109 and 1112 are disposed directly below (on the +Z direction side) the respective nozzles 1108 and 1111. The discharge heaters 1109 and 1112 generate air bubbles by applying a voltage and generating heat, and ink is discharged from the respective nozzles 1108 and 1111. The number of holes in the nozzle 1108 is 832, and the number of holes of the nozzle 1111 is 768. The nozzle 1108 is a nozzle for discharging black ink, and an Ev array 1121 (hereinafter also referred to as an Ev nozzle array) including the nozzles 1108 arranged in the Y direction at a pitch of 600 dpi and an Od array 1122 (hereinafter also referred to as an Od nozzle array) including the nozzles 1108 arranged in the Y direction at a pitch of 600 dpi are disposed. The Ev nozzle array 1121 is disposed with the nozzles 1108 a half pitch offset from the Od nozzle array 1122 in the −Y direction. By using the nozzle array 1101 with such a configuration for performing printing scanning, an image can be printed on the print medium with a print density of 1200 dpi.

In a similar manner for the nozzle array 1102, the nozzle array 1103, and the nozzle array 1104, each includes an Ev array 1123 to 1125 including the nozzles 1111 arranged in the Y direction at a pitch of 600 dpi and an Od array 1126 to 1128 including the nozzles 1111 arranged in the Y direction at a pitch of 600 dpi. The Ev array 1123 and the Od array 1126 correspond to the nozzle array 1102, the Ev array 1124 and the Od array 1127 correspond to the nozzle array 1103, and the Ev array 1125 and the Od array 1128 correspond to the nozzle array 1104. The Ev array 1123 to 1125 is disposed with the nozzles 1111 a half pitch offset from the Od array 1126 to 1128 in the −Y direction. In other words, an image forming apparatus 10 includes two or more nozzle arrays offset by half a pitch in the nozzle arrangement direction for the same color.

Note that in each embodiment described below, the print head H includes a print chip including a black nozzle array and a print chip including a cyan nozzle array, a magenta nozzle array, and a yellow nozzle array. However, the configuration of the print head H is not limited to such a configuration. Specifically, a black nozzle array, a cyan nozzle array, a magenta nozzle array, and a yellow nozzle array may also be installed in one chip. Alternatively, a print head installed with a print chip including a black nozzle array and a print head installed with a print chip including a cyan nozzle array, a magenta nozzle array, and a yellow nozzle array may be separately provided. Also, a black nozzle array, a cyan nozzle array, a magenta nozzle array, and a yellow nozzle array may each be installed in a separate print head. Also, the print head His a so-called bubble jet system in which ink is discharged by applying a voltage to a heater and generating heat, but the configuration is not limited to this. Specifically, the print head H may be configured to discharge ink using an electrostatic actuator or a piezo element.

### Printing System Configuration

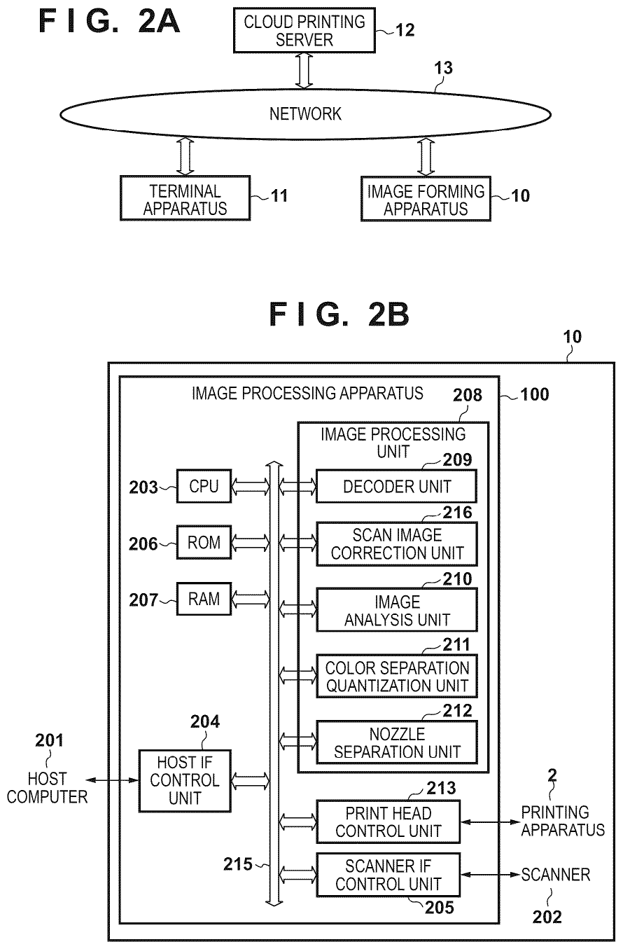

An example of the configuration of a printing system including the image forming apparatus 10 installed with the printing apparatus 2 described above will now be described using FIG. 2A. As illustrated in FIG. 2A, the printing system according to each embodiment described below includes a cloud printing server 12, a terminal apparatus 11, and the image forming apparatus 10, and each apparatus is connected to a network 13 such as a LAN or the Internet, forming a cloud printing system with this configuration.

The cloud printing server 12 is a server apparatus that provides a cloud printing service. In other words, with the configuration illustrated in FIG. 2A, the image forming apparatus 10 is a printer that supports cloud printing. The network 13 is a network including a wired network, a wireless network, or both. As the network 13, for example, the Internet, WAN, or a VPN environment is expected. However, the printing system is not limited to a cloud printing system. For example, the network 13 may be configured as an in-company LAN, and the terminal apparatus 11 and the image forming apparatus 10 may be configured to be directly connected without the network 13. Also, FIG. 2A illustrates a configuration in which the printing system includes one terminal apparatus 11 and one image forming apparatus 10. However, the number of terminal apparatuses 11 and image forming apparatuses 10 included in the printing system is not limited to one, and a plurality may be used. Also, the cloud printing server 12 may be a server system implemented using a plurality of information processing apparatuses. Also, the printing system may be a cloud printing system in which a plurality of cloud printing services cooperate.

The terminal apparatus 11 is an information processing apparatus such as a PC, a tablet terminal apparatus, or a smartphone and is installed with a cloud printer driver for a cloud printing service. On the terminal apparatus 11, any application software can be executed. For example, the terminal apparatus 11 generates a print job via the cloud printer driver on the basis of image data generated on the print application. Then, the terminal apparatus 11 transmits the generated print job to the image forming apparatus 10 registered in the cloud printing service via the cloud printing server 12. The image forming apparatus 10 is a device that prints images and text on a print medium such as paper and prints images and text on a print medium on the basis of a received print job.

### Control System Configuration

Next, an example of the hardware configuration of an image processing apparatus 100 that operates as a control system in the image forming apparatus 10 will be described using the block diagram of FIG. 2B. As an alternative configuration of the printing system, an apparatus including the image processing apparatus 100, the printing apparatus 2, and a scanner 202 may be configured as an apparatus separate to the image forming apparatus 10, and the apparatus may be configured to be able to communicate with the image forming apparatus 10. As another alternative configuration of the printing system, the image processing apparatus 100 may be included in a host computer 201, and in this case, the image processing apparatus 100 may include a print head control unit 213 and a scanner IF control unit 205.

The host computer 201 corresponds to the terminal apparatus 11, and the host computer 201 generates a print job including input image data (input image) which is data of an image or text for printing, print condition information (type and size of print medium, print quality, and similar information) specifying various conditions relating to printing and transmits the generated print job to the image forming apparatus 10.

The scanner 202 is a scanner device connected to the image processing apparatus 100 that converts a document placed on the scanner platform from analog data generated by optically reading the document into digital data via an AD converter. The scanning executed by the scanner 202 is executed in response to the host computer 201 transmitting a scan job to the image processing apparatus 100, but no such limitation is intended, and for example, and substitution is possible with a dedicated user interface (UI) apparatus connected to the image processing apparatus 100 and the scanner 202.

A CPU 203 executes various processing using computer programs and data stored in a RAM 207. Accordingly, the CPU 203 performs operation control of the entire image forming apparatus 10 and executes or controls various types of processing described below as processing executed by the image forming apparatus 10.

Setting data of the image forming apparatus 10, computer programs and data associated with activating the image forming apparatus 10, and computer programs and data associated with the basic operations of the image forming apparatus 10 are stored in a ROM 206. Computer programs and data for causing the CPU 203 and an image processing unit 208 to execute or control various types of processing described below as processing executed by the image forming apparatus 10 are also stored in the ROM 206.

A host IF control unit 204 controls the data communication with the host computer 201 and, for example, receives print jobs transmitted from the host computer 201. The CPU 203 stores received print jobs in the RAM 207.

The RAM 207 includes an area for storing computer programs and data loaded from the ROM 206 and an area for storing data received from the host computer 201 by the host IF control unit 204. Also, the RAM 207 includes an area for storing data received from the scanner 202 via the scanner IF control unit 205. The RAM 207 further includes a working area that is used when the CPU 203 and the image processing unit 208 execute various types of processing. In this manner, the RAM 207 is not limited to the areas described above and can appropriately provide various types of areas as necessary.

In accordance with print condition information included in a print job received from the host computer 201, the image processing unit 208 generates “nozzle data separated for each nozzle that can print” from input image data included in a print job. Then, the image processing unit 208 stores the generated nozzle data in the RAM 207. The functional units included in the image processing unit 208 will be described below.

The print head control unit 213 generates print data based on the nozzle data stored in the RAM 207 and controls the print head H described above included in the printing apparatus 2. Also, the print head control unit 213 sets a plurality of discharge position adjustment values stored in the RAM 207 for the nozzle arrays 1121 to 1128 and controls the discharge positions of the nozzles included in the nozzle arrays 1121 to 1128 in the main scan of the print head H. The control of the discharge position is performed using an encoder strip (not illustrated) installed in the printing apparatus 2.

The CPU 203, the ROM 206, the RAM 207, the host IF control unit 204, the image processing unit 208, the print head control unit 213, and the scanner IF control unit 205 are each connected to a shared bus 215 and can communicate data with one another.

### Overall Flow

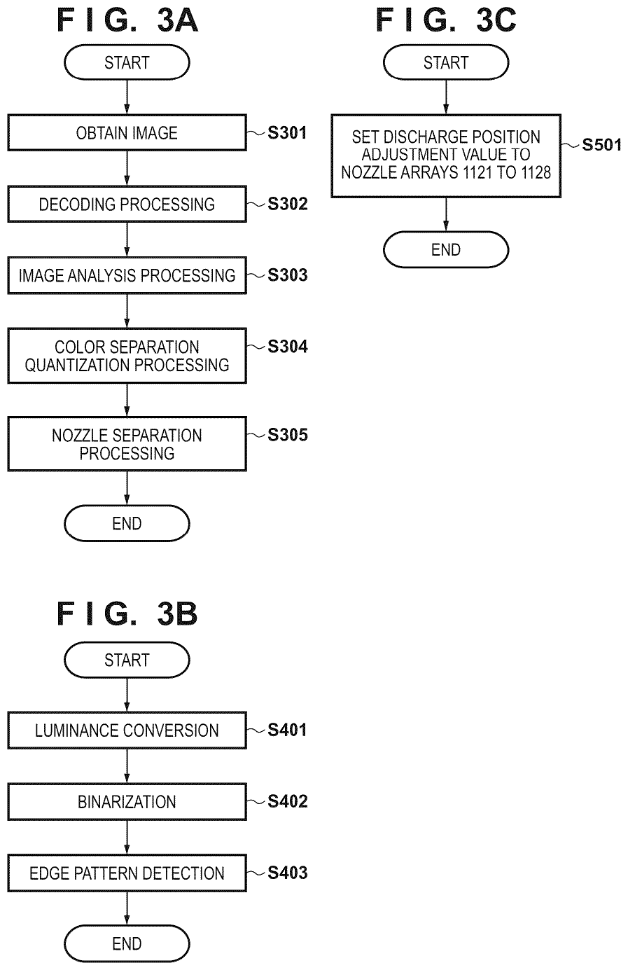

Next, the edge detection and image printing performed in the image processing unit 208 of the image forming apparatus 10 will be described using the flowchart of FIG. 3A. Via the processing according to the flowchart of FIG. 3A, input image data can be converted into nozzle data.

In step S301, the image processing unit 208 obtains the input image data stored in the RAM 207. In step S302, a decoder unit 209 executing decoding processing on the input image data obtained in step S301. Various types of save format may be used for the input image data, and typically a compression format such as JPEG is used to reduce the communication amount generated between the host computer 201 and the image forming apparatus 10. In a case where the save format of the input image data is JPEG, the decoder unit 209 decodes the input image data in the JPEG save format and converts the input image data into a bitmap image, which is an image in a bitmap format (information format with an image printed as consecutive values for pixel values).

In a case where the host computer 201 communicates with the image forming apparatus 10 via a dedicated driver or the like, a dedicated save format may be used. In the case of a dedicated save format which is suitable for both the driver and the image forming apparatus 10, the decoder unit 209 can converts the input image data into data of the dedicated save format. In accordance with, for example, the characteristics of an inkjet printing apparatus, save formats with different compression ratios can be applied to a region where information is desirably held at fine accuracy and other regions. If image quality wishes to be focused on instead of communication amount reduction, the input image data may be data in a bitmap format (a bitmap image). In this case, it is sufficient that the decoder unit 209 outputs the input image data in the bitmap format as is as a conversion result.

In step S303, an image analysis unit 210 executes image analysis processing on the bitmap image obtained as the decoding processing result of step S302. In each embodiment described below, by performing image analysis of the bitmap image, whether a target pixel is white paper or an end portion with a pixel formed of ink different from the target pixel is deduced on the basis of a feature in the bitmap image. Also, in each embodiment described below, which direction end portion of the up, down, left, and right direction the target pixel exists at in the shape formed by a pixel group is deduced. The processing of step S303 will be described below in detail using the flowchart of FIG. 3B.

In step S401, the image analysis unit 210 converts the pixel value of each pixel in the bitmap image obtained as the decoding processing result in step S302 into a luminance value (luminance conversion). For example, in a case where the pixel value of each pixel in the bitmap image is RGB 3 channel information, the information is converted into information (a luminance value) of one channel of luminance Y. Note that in a case where the image transmitted via the application is already represented in terms of luminance and similar cases where the luminance value is already obtained, the processing of step S401 can be omitted.

In step S402, the image analysis unit 210 converts the luminance value of each pixel in the bitmap image into a binary value (binary data) for edge detection. In each embodiment described below, for example, in accordance with Condition Formula (1) described below and using a threshold Th preset as a threshold corresponding to the print mode of the image forming apparatus 10 is used, comparison of the luminance value Y of each pixel in the bitmap image and the threshold Th is performed, and a binary value (Bin) corresponding to the luminance value Y is obtained.

$$IF Y > Th : Bin = 0 \qquad ( 1 )$$

$$else : Bin = 1$$

In other words, in a case where the luminance value Y of the pixel is greater than the threshold Th, the binary value Bin for edge detection of the pixel is “0”, and in a case where the luminance value Y of the pixel is equal to or less than the threshold Th, the binary value Bin for edge detection of the pixel is “1”. Note that the Condition Formula (1) is an example, and the design of an inequality condition and the form of a formula may be different.

In each embodiment described below, image analysis is performing using luminance as an index. In an inkjet printing apparatus, the tones using black ink in color separation are limited. This is because the change to the paper surface concentration of one drop of black ink is large on white paper and using a lot of black ink from lighter tone may lead to a degradation of image quality from the perspective of granularity. Thus, an ink generation position is easy to determine based on the luminance information of the input image data for black ink compared to other color ink. By setting the threshold Th to an appropriate value, it is possible to set, in the luminance information, a luminance value corresponding to a tone from which black ink is ejected by a predetermined amount or greater after ink separation. In each embodiment described below, the number and arrangement of dots of black ink and the number of arrangement of dots of other color ink adjacent to black ink can be controlled, and the use of the luminance values is under this control. However, each embodiment described below is not limited to this. For example, color separation may be performed in advance for the present analysis processing and a pixel where black ink is generated as a predetermined color component may be correctly comprehended. If color separation is performed in advance, pixels where cyan, magenta, and yellow inks are generated in addition to black ink and the discharge amounts can be comprehended, thus allowing for more detailed analysis. The input image data may be in the CMYK format or the like instead of the RGB format and may include information effective for analysis when it is the input image data. If the discharge amounts of cyan, magenta, and yellow inks are known, when the discharge amounts are small, color may be considered the same as white paper, and determination such as analysis of black ink generated in a region corresponding to white paper on the paper surface may be performed. In each embodiment described below, these determinations are expressed using the threshold Th. The threshold Th may be successively updated on the basis of the amount of wear of each nozzle of the nozzle arrays 1101 to 1104 of the print head H.

In step S403, the image analysis unit 210 performs edge pattern detection using the binary value Bin of each pixel in the bitmap image obtained via conversion processing of step S402.

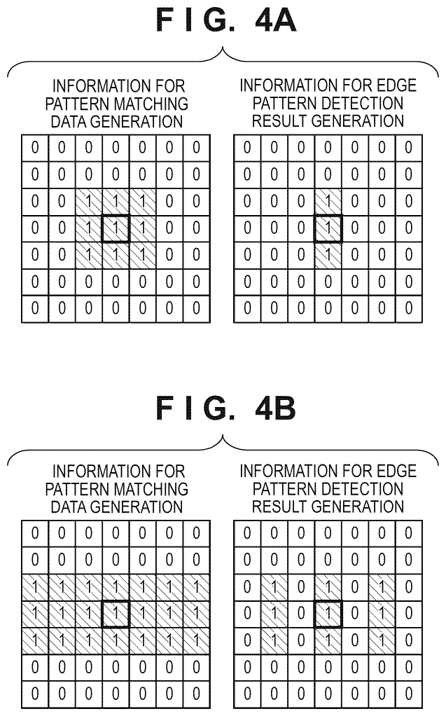

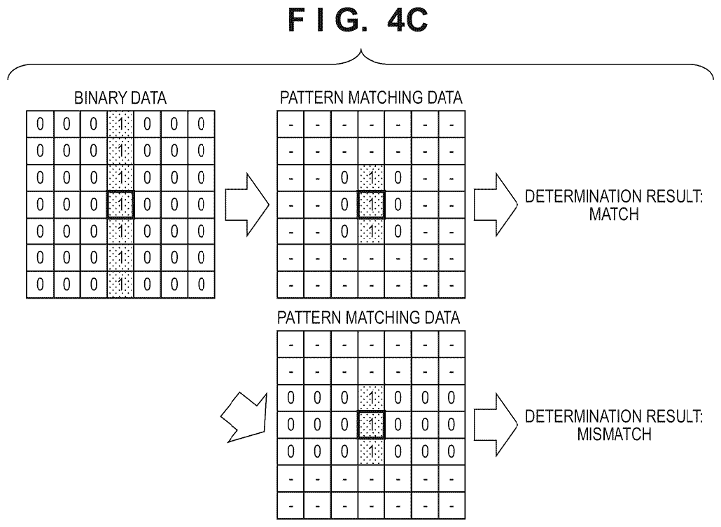

FIGS. 4A and 4B illustrate an example of pattern information for edge pattern detection. There are two types of pattern information, pattern information for pattern matching data generation and pattern information for edge pattern detection result generation.

The information for pattern matching data generation, which is pattern information for pattern matching data generation, is pattern information for performing bit AND processing for each pixel in a rectangular region in the “bitmap image in which the pixel value of each pixel is the binary value Bin” obtained in step S402. The pattern matching data obtained as a result of bit AND processing is obtained by extracting only the information required for detecting an edge pattern with respect to the rectangular region.

The information for edge pattern detection result generation, which is pattern information for edge pattern detection result generation, is pattern information for executing pattern matching processing on the pattern matching data. In a case where a complete match is obtained as the result of pattern matching processing, the corresponding rectangular region is determined to be a predetermined edge pattern. The determination result is associated with the central pixel in the rectangular region.

FIG. 4A illustrates examples of pattern information for determining whether a target pixel is “in a left/right end portion of a 1-dot vertical line”, with an example of information for pattern matching data generation illustrated on the left side and an example of information for edge pattern detection result generation illustrated on the right side.

In the information for pattern matching data generation, a value is set for performing edge pattern detection with 3×3 pixels including the target pixel as the target. A pixel assigned with “0” in the information for pattern matching data generation is considered a pixel not to be taken into account in pattern matching regardless of how the binary value Bin is formed.

The information for edge pattern detection result generation is a pattern corresponding to the predetermined edge pattern described above and, in the present example, is a pattern with 1 set for only three vertical pixels in the central column of the 3×3 pixels. The information for edge pattern detection result generation corresponds to a determination of low luminance for the three vertical pixels in the central column and high luminance for the other six pixels. In the case of pattern matching data that completely matches this pattern, it is found that there exists a high-luminance feature=white paper or low density color ink at least on the left and right and there exists a low-luminance feature=black ink in the target pixel and the upper and lower pixels thereof.

FIG. 4B illustrates examples of pattern information for determining whether a target pixel is “in a left/right end portion of a 1-dot vertical line” as well as “in a portion of 1 dot 1 space”, with an example of information for pattern matching data generation illustrated on the left side and an example of information for edge pattern detection result generation illustrated on the right side.

“1 dot 1 space” indicates a pattern with a plurality of 1-dot vertical lines disposed at 1-dot intervals. By expanding the range of the information for pattern matching data generation to 7×3 pixels, information of the surroundings of a 1-dot line to which the target pixel belongs can be included in the determination.

FIG. 4C illustrates the result of successively performing the pattern matching of FIGS. 4A and 4B on binary data. When the information for pattern matching data generation and the information for edge pattern detection result generation of FIG. 4A is applied on the target binary data, a determination result of “match” is determined. Also, when the information for pattern matching data generation and the information for edge pattern detection result generation of FIG. 4B is applied, a determination result of “no match” is determined. On the basis of the detection result of the two patterns, it is found that the target binary data is “in a left/right end portion of a 1-dot vertical line” and “not in a portion of 1 dot 1 space”.

Using the method described above, diverse edge patterns can be detected. According to each embodiment described below, 7×7 pixels are the target of pattern matching, but this is merely an example. For example, it is sufficient that the pattern of FIGS. 4A and 4B are detectable, and 7×3 pixels are sufficient for the target of the pattern matching. In a case where a linear shape of 4-dot or more line is desired to be separately detected, 7×7 pixels are not sufficient, and a wider region may be set as the target. Widening the target makes more working memory necessary for holding binary data for comparison and more working memory necessary for holding the pattern information. The working memory corresponds to the RAM 207. In a case where the image analysis unit 210 is a dedicated circuit, when it is desirable to process a plurality of pixels by performing pattern matching by a parallel clk, the numbers of processing registers and processing circuits increase. Also, since the pattern information needs to be held in the ROM 206 of the image processing apparatus 100 in advance, capacity of the ROM 206 is also required. In a case where the edge pattern is confirmed in a detailed or diverse manner, more pattern information needs to be held. Thus, the design needs to take into account the memory capacity and an increase in the analysis time caused by an increase in the number of times comparison is performed. Performing a determination of “0” in the information for pattern matching data generation=“not taken into account in pattern matching” contributes to reducing the memory capacity and to reducing the number of times comparison is performed.

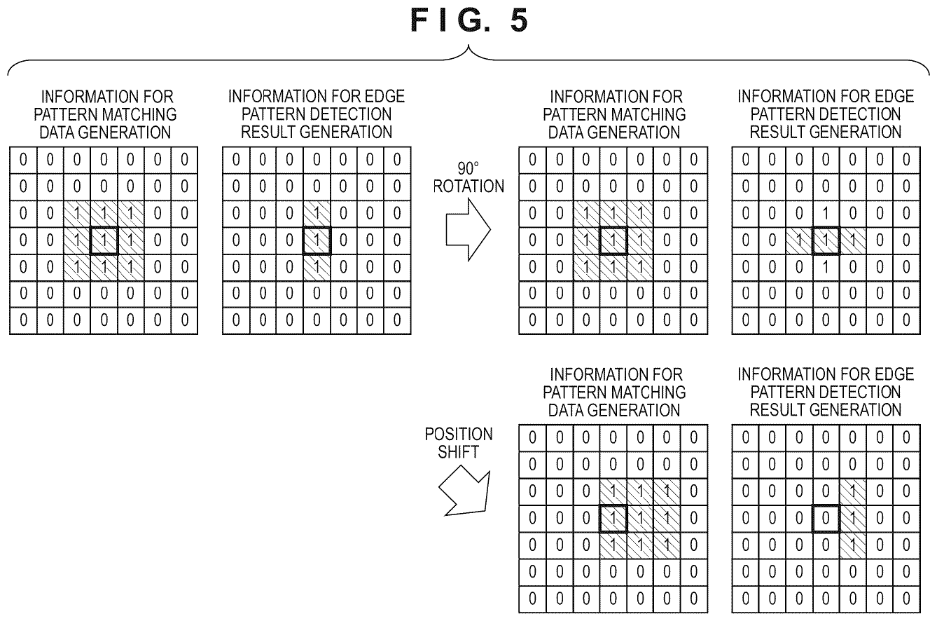

In another configuration for reducing the memory capacity, as illustrated in FIG. 5, it is also possible to perform pattern matching of another variation by processing such as rotation or phase shifting. On the upper side of FIG. 5, the pattern information illustrated in FIG. 4A is rotated by 90°, and it is possible to determine that the target pixel is “in the upper/lower end portion of a 1-dot horizontal line” using the post-processing pattern information. On the lower side of FIG. 5, the pattern information illustrated in FIG. 4A is horizontally shifted by 1 pixel, and it is possible to determine that the target pixel is “an adjacent pixel of a 1-dot vertical line” using the post-processing pattern information. In FIG. 5, variations are increased by processing the pattern information. However, variations can be increased by processing the binary data side.

As illustrated in FIG. 4C, it is effective to narrow a determination result by successively applying a plurality of pieces of pattern information and to obtain information that is not known by individual pattern information. For example, when “match” with the pattern illustrated in FIG. 4A is determined in FIG. 4C, it may be unnecessary to perform determination with respect to a 2-dot or more line prepared in advance. An effect of decreasing the number of times comparison is performed is obtained by applying only the pattern information for determining more detailed information of the 1-dot line, as illustrated in FIG. 4B. By applying FIG. 4A or 4B, it is found that the target binary data is “in the left/right end portion of a 1-dot vertical line” and “not in a portion of 1 dot 1 space”. Not by preparing obtainable individual pattern information but by deriving that information from the results of FIGS. 4A and 4B, an effect of reducing the memory capacity is obtained. As described above, via the processing described above, it is possible to determine whether each pixel is a pixel to undergo special processing such as processing of downsampling dots or processing of changing the arrangement of dots.

The determination result of the image analysis processing in step S303 described above is output in an information format suitable for processing in the subsequent step. For example, the determination result can be expressed by 3-bit multi-valued data such as non-detection (no correspondence to any detection pattern)=0, upper end portion detection=1, lower end portion detection=2, left end portion detection=3, right end portion detection=4, and adjacent to one of the end portions=5. Alternatively, expression of assignment of each bit within 5 bits is also possible, such as non-detection=00000, upper end portion detection=00001, lower end portion detection=00010, left end portion detection=00100, right end portion detection=01000, and adjacent to one of the end portions=10000. The former can transmit the determination result to the next processing with a small data amount. The latter has the merit of reducing the processing load since bit processing can be used in the next processing. It has been described that the five pieces of information are transmitted to the subsequent step. However, as described in step S303 that “the pattern information can diversely be expressed”, information more than control information necessary for the subsequent processing steps may be detected and transmitted.

Below, various embodiments will be described of technology for downsampling and printing a two-dimensional code image when a mode for two-dimensional code image printing that is not a mode for text printing is set.

### First Embodiment

In the case according to the present embodiment described herein, the image forming apparatus 10 includes a printing mode for executing edge processing prioritizing enhancing the readability of text and a printing mode for executing edge processing prioritizing enhancement of the scanning accuracy of a two-dimensional code image such as a barcode and a QR code.

### Text Readability Enhancing Edge Processing

Edge processing for enhancing the readability of text (text readability enhancing edge processing) is applied to only black ink with relatively low brightness and with ink bleeding that easily stands out, but is a color typically used in document printing.

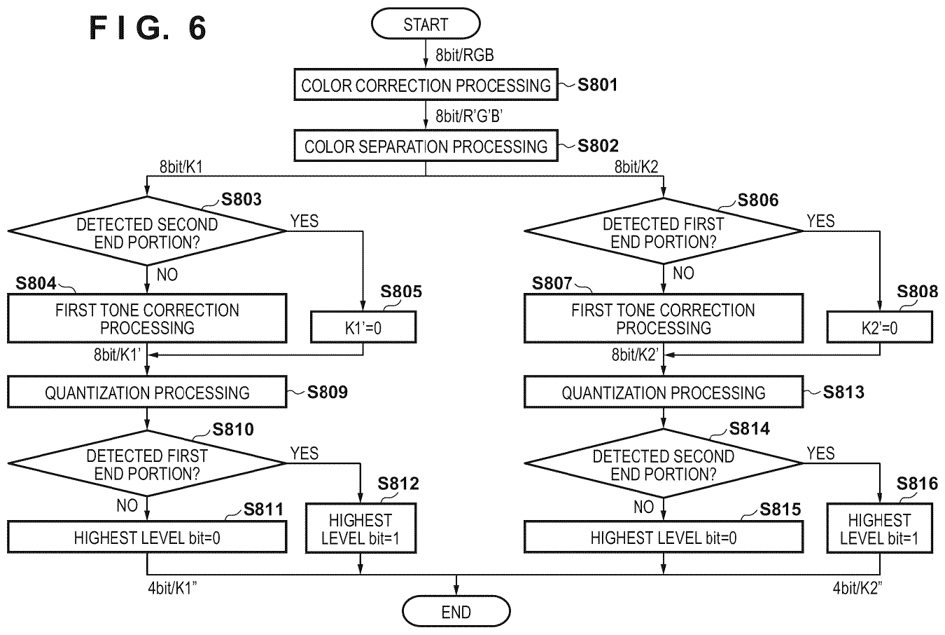

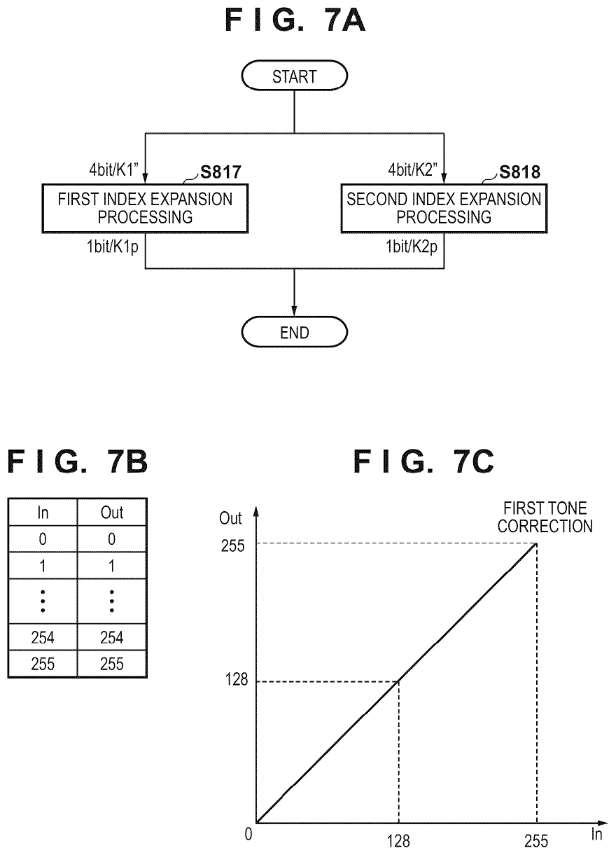

FIGS. 6 and 7A are flowcharts illustrating in detail color separation quantization processing executed in step S304 and nozzle separation processing executed in step S305.

In the following description, it is assumed that in the bitmap image obtained as a result of decoding processing of step S302, each of the pixels arranged at 600 dpi includes an 8-bit 256 tone luminance value for each of red (R), green (G), and blue (B).

Also, in the end portion information detected in step S303, the upper end portion, the lower end portion, the right end portion, and the left end portion are defined as pixels with the binary value Bin that changes from 1 to 0 in the −Y direction, the +Y direction, the +X direction, and the −X direction, respectively and are on the side where the binary value Bin=1. Since nozzles of each color of the print head H are arranged at a dpi of 1200 in the Y direction per color, each pixel is printed using the consecutive Ev array nozzles (hereinafter referred to as Ev nozzles) and the Od array nozzles (hereinafter referred to as Od nozzles). Here, the nozzle located on the upper end portion side of each pixel is defined as an upstream nozzle, and the nozzle located on the lower end portion side of each pixel is defined as a downstream nozzle. In the present embodiment, the upstream nozzle corresponds to the Ev nozzle, and the downstream nozzle corresponds to the Od nozzle. In other words, in the present embodiment, the print resolution in the Y direction is twice the resolution of the image for edge pattern detection.

In step S801, a color separation quantization unit 211 executes color correction processing including converting the luminance values RGB (RGB data) of each pixel in the bitmap image obtained as a result of the decoding processing of step S302 into luminance values R′G′B′ (R′G′B′ data) expressed in a color space specific to the image forming apparatus 10. For example, the RGB data can be converted into R′G′B′ data by referencing a look-up table stored in advance in memory such as the ROM 206.

In step S802, the color separation quantization unit 211 executes color separation processing on the R′G′B′ data. Specifically, the color separation quantization unit 211 references the look-up table stored in advance in a memory such as the ROM 206 and converts the luminance values R′G′B′ of each pixel into 8-bit, 256-tone density values CMYK corresponding to the ink color used by the image forming apparatus 10. Also, the color separation quantization unit 211 duplicates the density values of one or more colors of CMYK and prepares a total of two density values which are the same. For the sake of simplicity, in the example given below, a density value for K is duplicated to generate a density value K1 and a density value K2. Note that the density value K1 and the density value K2 are each applied to the Ev nozzle and the Od nozzle in the nozzle array 1101 via the processing described below.

Then, in steps S803 to S805, the color separation quantization unit 211 executes tone correction processing based on whether or not the pixel to be processed is a second end portion for the density value K1. Also, in steps S806 to S808, the color separation quantization unit 211 executes tone correction processing based on whether or not the pixel to be processed is a first end portion for the density value K2.

Here, tone correction processing is correction for giving the input density value and an optical density expressed by the print medium P are linear relationship. Via such tone correction processing, the 8-bit, 256-tone density values K1 and K2 are converted into matching 8-bit, 256-tone density values K1′ and K2′, respectively.

In a case where the pixel to be processed is determined to be a second end portion in step S303, the processing advances to step S805 via step S803. In a case where the pixel to be processed is determined to not be a second end portion, the processing advances to step S804 via step S803.

In step S805, the color separation quantization unit 211 converts the density value K1 of the pixel to be processed into a density value K1′=0. In step S804, the color separation quantization unit 211 converts the density value K1 of the pixel to be processed into the density value K1′ via first tone correction processing.

In a case where the pixel to be processed is determined to be a first end portion in step S303, the processing advances to step S808 via step S806. In a case where the pixel to be processed is determined to not be a first end portion, the processing advances to step S807 via step S806.

In step S808, the color separation quantization unit 211 converts the density value K2 of the pixel to be processed into a density value K2′=0. In step S807, the color separation quantization unit 211 converts the density value K2 of the pixel to be processed into the density value K2′ via first tone correction processing.

FIGS. 7B and 7C are diagrams illustrating the first tone correction processing, with In corresponding to the density value K1 (K2) and Out corresponding to the density value K1′ (K2′). In the examples according to the present description, for the sake of simplicity, In and Out have a linear relationship.

In step S809, the color separation quantization unit 211 executes quantization processing on the density value K1′ and converts it into either “0000”, “0001”, or “0010” 4-bit, 3 value quantization data (quantization value). In the present example, the quantization values are expressed as three values for low density, medium density, and high density.

In a case where the pixel to be processed is determined to be a first end portion in step S303, the processing advances to step S812 via step S810. In a case where the pixel to be processed is determined to not be a first end portion, the processing advances to step S811 via step S810.

In step S812, the color separation quantization unit 211 generates a 4-bit quantization value K1″, with the highest level bit of the quantization value of the density value K1′ of the pixel to be processed set to 1. In step S811, the color separation quantization unit 211 generates the 4-bit quantization value K1″, with the highest level bit of the quantization value of the density value K1′ of the pixel to be processed set to 0.

In step S813, the color separation quantization unit 211 executes quantization processing on the density value K2′ and converts it into either “0000”, “0001”, or “0010” 4-bit, 3 value quantization data (quantization value). In the present example, the quantization values are expressed as three values for low density, medium density, and high density.

In a case where the pixel to be processed is determined to be a second end portion in step S303, the processing advances to step S816 via step S814. In a case where the pixel to be processed is determined to not be a second end portion, the processing advances to step S815 via step S814.

In step S816, the color separation quantization unit 211 generates a 4-bit quantization value K2″, with the highest level bit of the quantization value of the density value K2′ of the pixel to be processed set to 1. In step S815, the color separation quantization unit 211 generates the 4-bit quantization value K2″, with the highest level bit of the quantization value of the density value K2′ of the pixel to be processed set to 0.

In step S305, a nozzle separation unit 212 executes index expansion processing for the quantization values K1″ and K2″ generated in step S304. In the index expansion processing according to the present embodiment, the quantization values K1″ and K2 of 600 dpi×600 dpi are converted into binary nozzle data K1p and K2p of 600 dpi×600 dpi using an index pattern prepared in advance. In other words, in step S817, the nozzle separation unit 212 generates the nozzle data K1p by executing first index expansion processing for the quantization value K1″. Also, in step S818, the nozzle separation unit 212 generates the nozzle data K2p by executing second index expansion processing for the quantization value K2″.

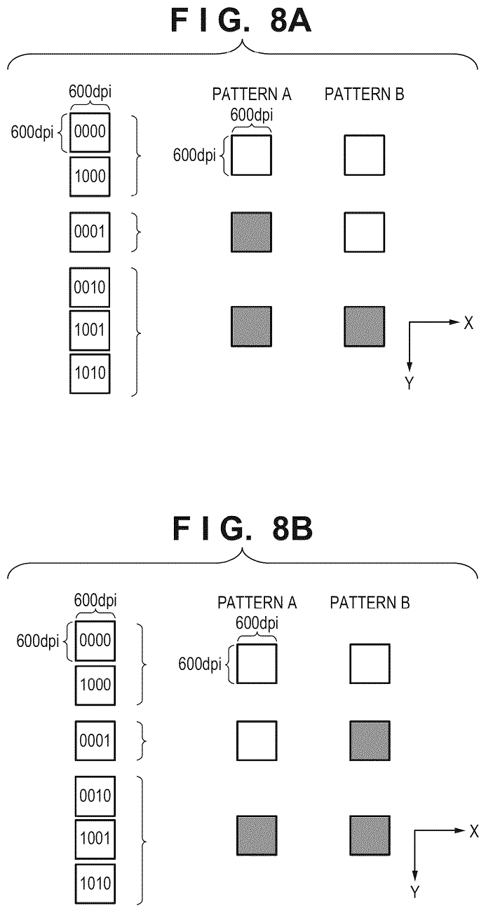

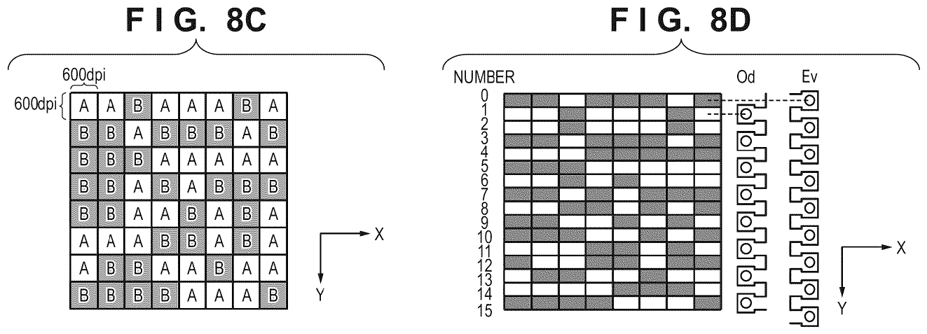

Here, an index pattern is, in other words, a dot arrangement pattern for arranging dots in a pixel. FIGS. 8A to 8D are diagrams illustrating an example of a dot arrangement pattern and a reference index pattern used in the index expansion processing. FIG. 8A is a diagram illustrating a dot arrangement pattern of the first index expansion processing. In a case where the quantization value K1″ of one pixel of 600 dpi×600 dpi indicates “0000” or “1000”, a dot is not arranged in the pixel. In a case where the quantization value K1″ indicates “0001”, a pattern A with a dot arranged and a pattern B with a dot not arranged are prepared. In cases where the quantization value K1″ is “0010”, “1001”, or “1010”, a dot is arranged in the pixel.

FIG. 8B is a diagram illustrating a dot arrangement pattern of the second index expansion processing. In a case where the quantization value K2″ of one pixel of 600 dpi×600 dpi indicates “0001”, a pattern A with a dot not arranged and a pattern B with a dot arranged are prepared. In a case where the quantization value K2″ indicates either “0000”, “1000”, “0010”, “1001”, or “1010”, the processing is the same as in the first index expansion processing.

FIG. 8C is a diagram illustrating an example of the reference index pattern. In the present embodiment, different index patterns are used in the first index expansion processing and the second index expansion processing, but both are generated based on the reference index pattern of FIG. 8C. In the reference index pattern, each rectangle corresponds to one pixel of 600 dpi×600 dpi, and for each pixel it is determined whether to arrange a dot per pattern A or arrange a dot per pattern B. The nozzle separation unit 212 generates the nozzle data K1p of each pixel after the first index expansion processing as data for the Ev nozzle of the nozzle array 1101 corresponding to the pixel and stores this in the RAM 207. Then, the nozzle separation unit 212 generates the nozzle data K2p of each pixel after the second index expansion processing as data for the Od nozzle of the nozzle array 1101 corresponding to the pixel and stores this in the RAM 207.

FIG. 8D illustrates the binary data of 600 dpi in the X direction and 1200 dpi in the Y direction after the index expansion processing and the positional relationship between this data and the nozzles of the nozzle array 1101 in a case where all of the quantization values of each pixel are uniformly “0001” (medium density). As illustrated in FIG. 8D, dots are formed by the Ev nozzles for the Oth, second, fourth, . . . (even-numbered) quantization values in the Y direction, and dots are formed by the Od nozzles for the first, third, fifth, . . . (odd-numbered) quantization values in the Y direction. Thus, printing/non-printing of each nozzle of the nozzle array 1101 is set for each pixel of the input image data of 600 dpi×600 dpi, thus setting printing/non-printing of 600 dpi×1200 dpi.

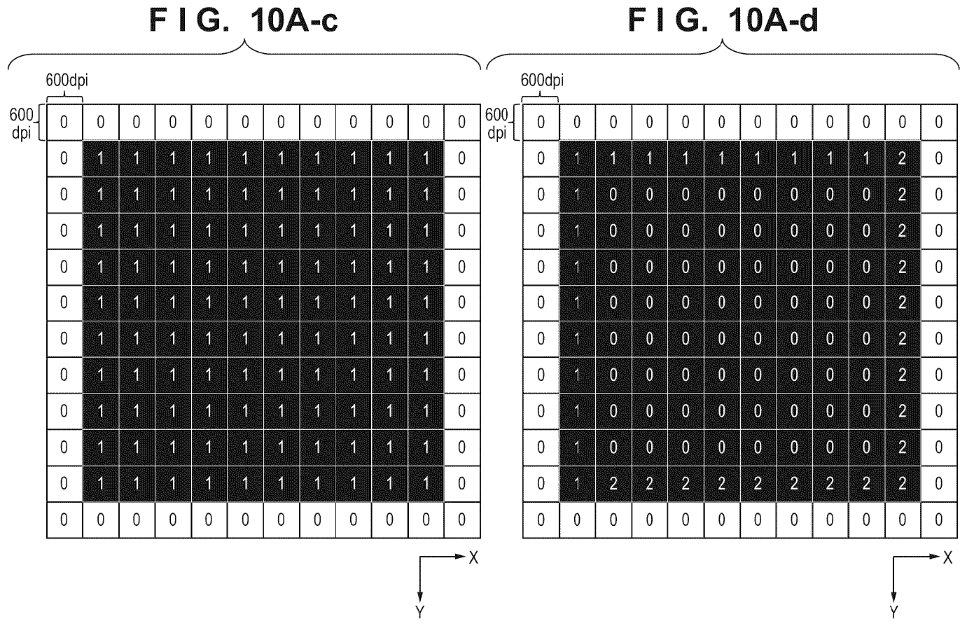

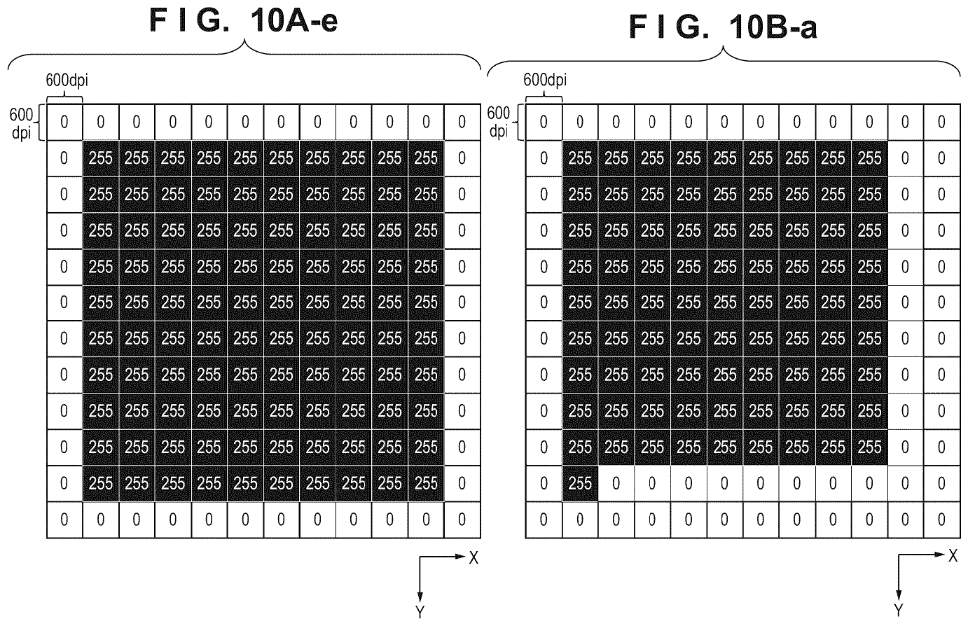

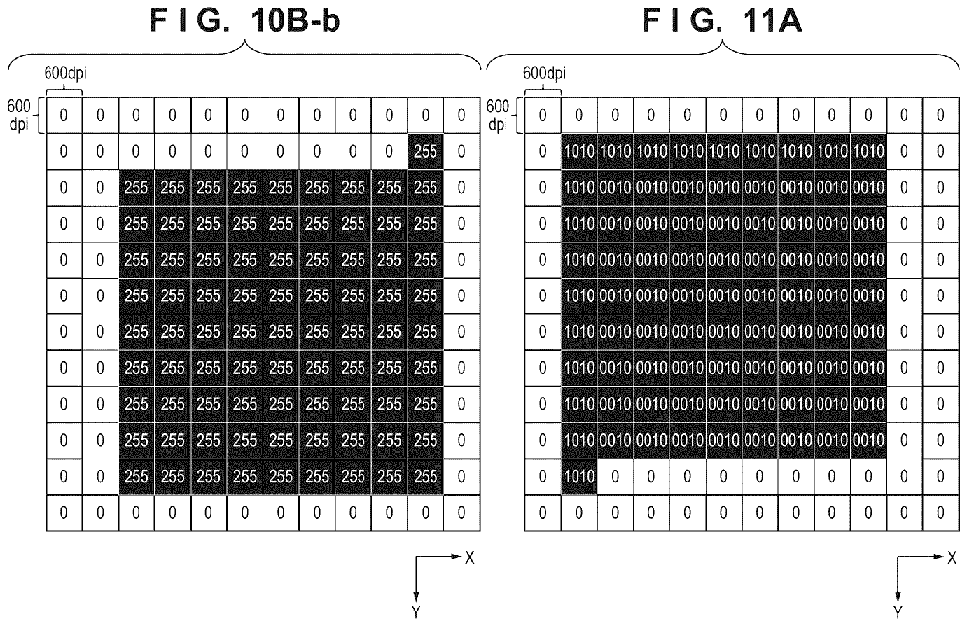

FIG. 10A-a is a diagram illustrating an example of input image data including an object (edge region) including an upper end pixel, a lower end pixel, a left end pixel, and a right end pixel, with the pixels being arranged at 600 dpi and each pixel being a so-called “black pixel” with an 8-bit, 256-tone luminance value of 0 for each of R, G, and B.

First, after the input image data is obtained by the image processing unit 208 in step S301, decoding processing is executed by the decoder unit 209 in step S302. However, for the sake of simplicity, in this example, the post-decoding-processing input image data is similar to that illustrated in FIG. 10A-a.

In step S303, the image analysis unit 210 detects which end portion each pixel in the post-decoding-processing input image data corresponds to. FIG. 10A-b is a diagram illustrating data of the luminance Y after luminance conversion in step S401. FIG. 10A-c is a diagram illustrating the binary value Bin for the data of the luminance Y obtained via binarization using Th=50 in step S402. FIG. 10A-d is a diagram illustrating the result of edge determination on the binary values Bin. In this example, in FIG. 10A-d, “0” indicates non-detection, “1” indicates an upper end portion or a left end portion, and “2” indicates a lower end portion or a right end portion.

Next, in step S304, the bitmap image obtained via the decoding processing in step S302 is subjected to color separation quantization processing by the color separation quantization unit 211 on the basis of the edge end portion detection result (end portion information) in step S303. FIG. 10A-e is a diagram illustrating the density value K1 and the density value K2 after the color separation processing in step S802.

FIG. 10B-a is a diagram illustrating the density value K1′ after the tone correction processing of steps S803 to S805, and in this example, the second end portion is determined as a lower end portion and a right end portion in step S803. Thus, the pixels indicating “2” in FIG. 10A-d, that is, the lower end portion and the right end portion pixels have a density value of 0.

FIG. 10B-b is a diagram illustrating the density value K2′ after the tone correction processing of steps S806 to S808, and in this example, the first end portion is determined as an upper end portion and a left end portion in step S806. Thus, the pixels indicating “1” in FIG. 10A-d, that is, the upper end portion and the left end portion pixels have a density value of 0.

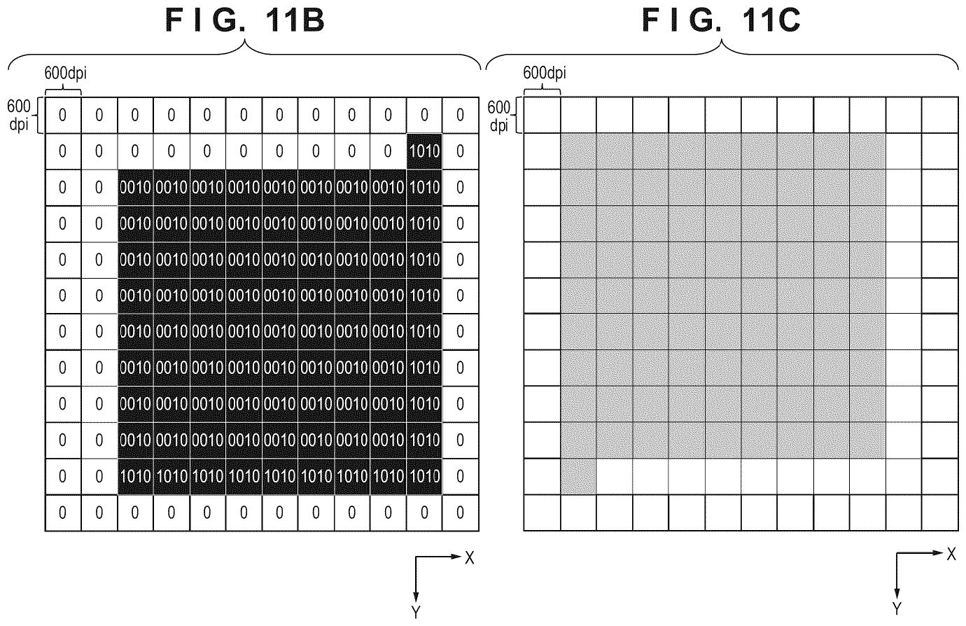

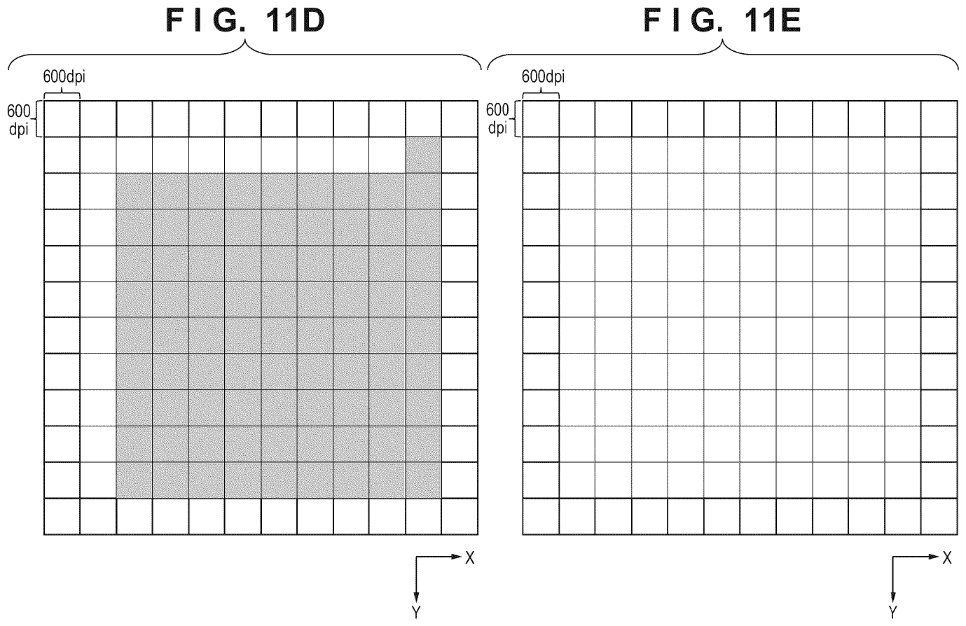

FIG. 11A is a diagram illustrating the quantization value K1″ obtained after the processing of steps S809 to S812, and FIG. 11B is a diagram illustrating the quantization value K2″ obtained after the processing of steps S813 to S816. In the example illustrated here, the density values 128 are quantized to “0001” and the density values 255 are quantized to “0010” in the steps S809 and S813. Also, the definition of the first end portion and the second end portion in steps S810 and S814 are similar to that in steps S806 and S803. Thus, as illustrated in FIG. 11A, of the pixels with the density value K1′=255 in FIG. 10B-a, the pixels indicating “1” in FIG. 10A-d, that is, the upper end portion pixels become the quantization value “1010” and other pixels become “0010”. On the other hand, as illustrated in FIG. 11B, of the pixels with the density value K2′=255 in FIG. 10B-b, the pixels indicating “2” in FIG. 10A-d, that is, the lower end portion pixels become the quantization value “1010” and other pixels become “0010”.

Next, in step S305, the bitmap image quantized in step S304 is subjected to index expansion processing by the nozzle separation unit 212. FIGS. 11C and 11D are each diagrams illustrating the nozzle data K1p and K2p after the index expansion processing of steps S817 and S818. FIG. 11E is a diagram illustrating the dot arrangement when the print head H performs printing at 600 dpi×1200 dpi on the basis of the nozzle data K1p and the nozzle data K2p. By comparing FIGS. 10A-a, 10A-d, and 11E, it can be found that, of the pixels with a luminance value of 0 in FIG. 10A-a, the pixels that are not the upper end portion, the lower end portion, the left end portion, and the right end portion in FIG. 10A-d have dots arranged in each region of the 600 dpi×1200 dpi of FIG. 11E. Also, as in FIG. 11E, it can be found that, of the pixels with a luminance value of 0 in FIG. 10A-a, the pixels determined to be the upper end portion and the left end portion in FIG. 10A-d have dots arranged only for the upstream nozzles, that is, the Ev nozzles. Also, as in FIG. 11E, it can be found that, of the pixels with a luminance value of 0 in FIG. 10A-a, the pixels determined to be the lower end portion and the right end portion in FIG. 10A-d have dots arranged only for the downstream nozzles, that is, the Od nozzles.

As described above, in the text readability enhancing edge processing, compared with an image for edge detection, with an apparatus configuration configured to print dots at a high resolution in the Y direction, the upper end portion pixels and the left end portion pixels are determined as first end portions on the object side of an edge portion of an object in the image, and the lower end portion pixels and the right end portion pixels are determined as the second end portions. Then, by changing the arrangement of the dots according to the determination result, the dots of the end portions are downsampled. In the present embodiment, image quality degradation due to bleeding of ink on the print medium can be reduced by downsampling dots of edge pixels, and for upper end portion pixels and lower end portion pixels, degradation of readability due to lines becoming too thin due to downsampling of dots of regions (hereinafter also referred to as non-end portions) more to the inner side of an object can be reduced.

The text readability enhancing edge processing is applied to only black ink. However, in a case where ink bleeding easily stands out at the boundary portion between black and a yellow, such as the case of black text on a yellow background, yellow pixels adjacent to black pixels may be detected via the method described above and dots may be downsampled.

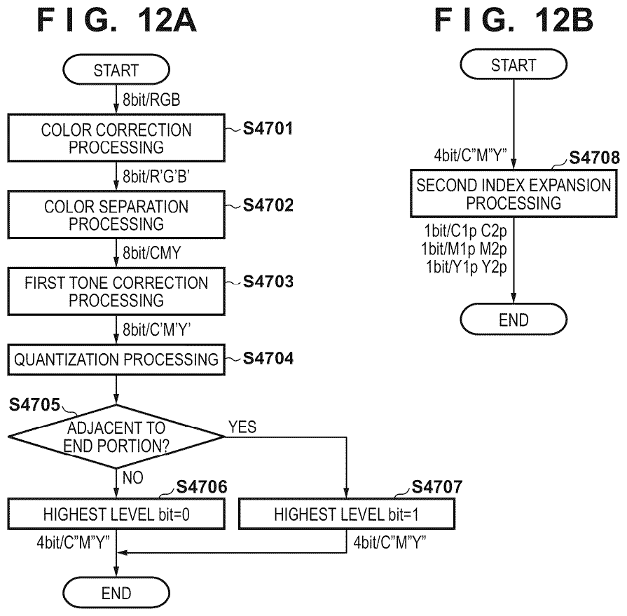

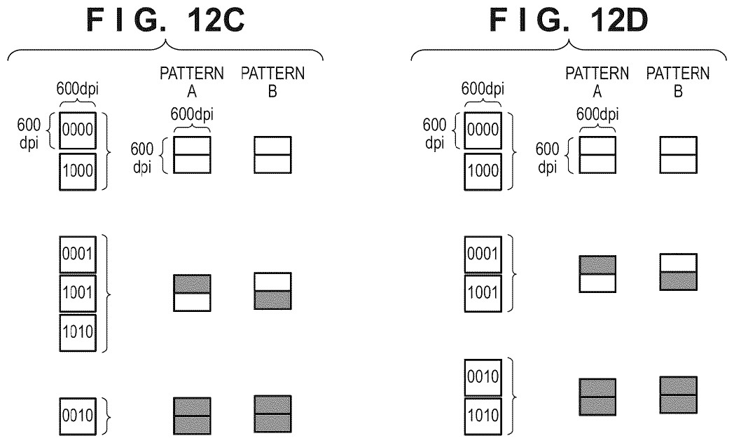

FIGS. 12A and 12B are flowcharts illustrating in detail color separation quantization processing executed in step S304 and nozzle separation processing executed in step S305 for cyan, magenta, and yellow.

Note that steps S4701 and S4702 in FIG. 12A are similar to the processing in steps S801 and S802 in FIG. 6, and thus these steps will not be described. Also, steps S4703 and S4704 in FIG. 12A are similar to the processing in steps S804 and S809 in FIG. 6, and thus these steps will not be described.

Via the processing of step S4701, 8-bit RGB of each pixel is converted to 8-bit R′G′B′, and via the processing of step S4702, 8-bit R′G′B′ is converted to 8-bit CMY. Then, via the processing of step S4703, 8-bit CMY is converted to 8-bit C′M′Y′, and via the processing of step S4704, 8-bit C′M′Y′ is converted to 4-bit C′M′Y′ (quantization value).

In step S4705, the color separation quantization unit 211 determines whether the pixel to be processed is a pixel adjacent to a certain end portion on the basis of the end portion information detected in step S303. Here, “a certain end portion” corresponds to the first end portion or the second end portion, for example.

In a case where the pixel to be processed is found via the determination result to be a pixel adjacent to a certain end portion, the processing advances to step S4707. In a case where the pixel to be processed is not a pixel adjacent to an end portion, the processing advances to step S4706.

In step S4707, the color separation quantization unit 211 generates a 4-bit quantization value C″M″Y″, with the highest level bit of the 4-bit C′M′Y′ (quantization value) set to 1. In step S4706, the color separation quantization unit 211 generates a 4-bit quantization value C″M″Y″, with the lowest level bit of the 4-bit C′M′Y′ (quantization value) set to 0.

In step S4708, a nozzle separation unit 212 executes second index expansion processing on the quantization values C″, M″, Y″ generated in step S304. In the second index expansion processing, the quantization values C″, M″, Y″ of 600 dpi×600 dpi are converted into binary nozzle data C1p, C2p, M1p, M2p, Y1p, and Y2p of 600 dpi×600 dpi using an index pattern prepared in advance.

FIGS. 12C and 12D are diagrams illustrating an example of the dot arrangement pattern used in the index expansion processing. FIG. 12C illustrates the dot arrangement pattern for Y″, and FIG. 12D illustrates the dot arrangement pattern for C″ and M″. The dot arrangement patterns illustrated in FIGS. 12C and 12D are formed of arrangement information of 600 dpi×1200 dpi being connected vertically. For each of the quantization values C″, M″, Y″, in a case where “0000” or “1000” is indicated, in the pixel, a dot of that color is not arranged in the upper side and the lower side. For each of the quantization values C″, M″, Y″, in a case where “0001” is indicated, a pattern A with a dot of the color arranged on the upper side and a pattern B with a dot of the color arranged on the lower side are prepared. For each of the quantization values C″, M″, Y″, in a case where “0010” is indicated, in the pixel, a dot of that color is arranged in the upper side and the lower side. For each of the quantization values C″, M″, also in a case where “1010” is indicated, in the pixel, a dot of that color is arranged in the upper side and the lower side.

On the other hand, in a case where “1010” is indicated for the quantization value Y″, a pattern A with a dot of the color arranged on the upper side and a pattern B with a dot of the color arranged on the lower side are prepared. The reference index pattern is similar to that of FIG. 8C. Then, of the upper/lower arrangement information of the cyan dots of each pixel, the upper side data is generated as data for the Ev nozzles of the nozzle array 1102 corresponding to each pixel as the nozzle data C1p and stored in the RAM 207 by the nozzle separation unit 212. Also, of the upper/lower arrangement information of the cyan dots of each pixel, the lower side data is generated as data for the Od nozzles of the nozzle array 1102 corresponding to each pixel as the nozzle data C2p and stored in the RAM 207 by the nozzle separation unit 212. Note that the nozzle separation unit 212 also executes similar processing for magenta and yellow.

Accordingly, for cyan and magenta, the same dot arrangement is used regardless of whether the pixel is adjacent to a certain end portion, and thus dot downsampling is not performed. For yellow however, in a case where the pixel is adjacent to a certain end portion, dot downsampling is performed. In the example described here, dot downsampling is performed for yellow when the pixel is adjacent to a certain end portion. However, in another example, downsampling may be performed when the pixel is adjacent to a certain end portion for cyan and magenta and not only yellow.

### Code Image Scanning Accuracy Enhancing Edge Processing

A two-dimensional code image such as a barcode, a QR code, an SP code, a Vericode, a Maxicode, a CP code, a DataMatrix, a PDF417, or the like is an image of a geometric pattern representing information via an arrangement of dark (bar, cell) and light (space) according to a specific rule. In order to scan two-dimensional code images accurately, it is important that the bar, cells, and spaces are printed at the correct dimensions set by the standard. In particular, a QR code has a high cell number when it represents a large amount of information, and if it is being printed in a limited space on a print medium, it tends to be easily affected by ink bleeding. In practice, if the width (based on ISO 13660) of the printed line is thicker than an ideal line width for input due to ink bleeding, it is found that the scan grade (based on ISO/IEC 15416 and ISO/IEC 15415) of the two-dimensional code image printed using the same printing control is degraded. Also, since smartphones have recently become more common and anyone can scan a two-dimensional code image, there are increasingly more cases of colorful two-dimensional code images such as design QR codes and the like being output.

In light of the foregoing, in code image scanning accuracy enhancing edge processing according to the present embodiment, in order to achieve the ideal line width for input, the downsampling rate is set high and edge processing is applied to color ink as well as black ink.

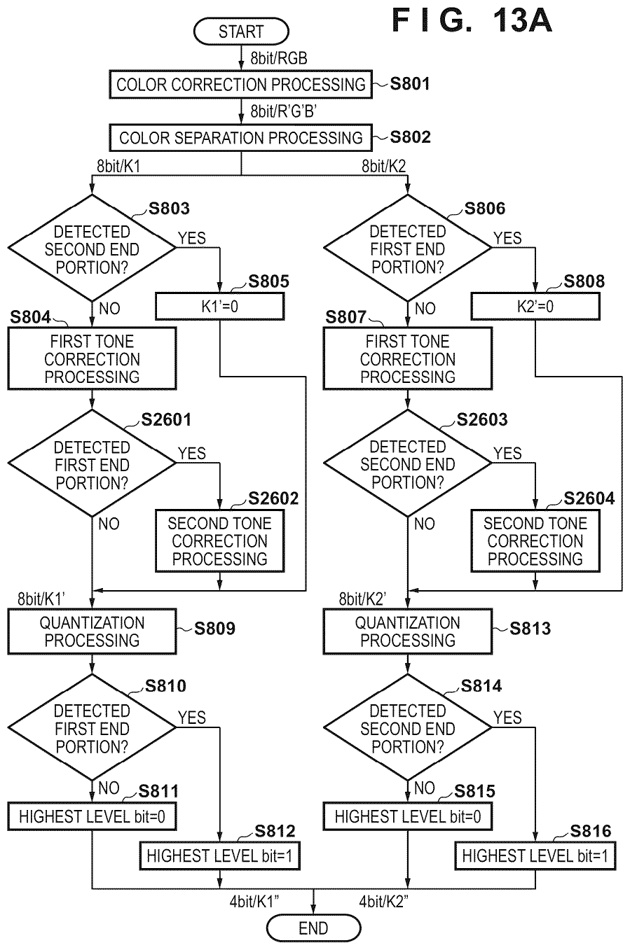

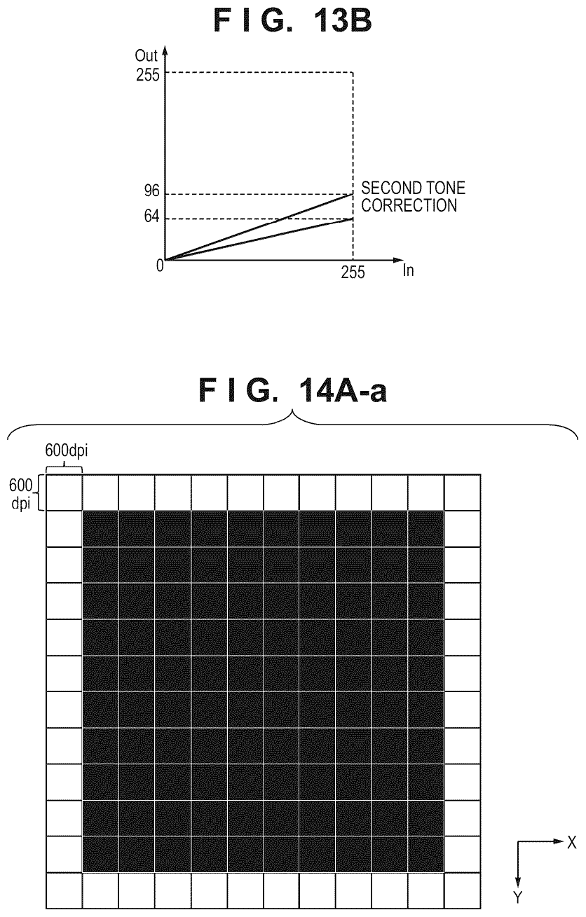

FIG. 13A is a flowchart illustrating in detail the color separation quantization processing executed in step S304. In the flowchart of FIG. 13A, processing steps that are similar to the processing steps of FIG. 6 are given the same step number as the processing step and description thereof is omitted.

In step S2601, the color separation quantization unit 211 determines whether or not the pixel to be processed is a first end portion. In a case where, according to the determination result, the pixel to be processed is a first end portion, the processing advances to step S2602. In a case where the pixel to be processed is not a first end portion, the processing advances to step S809.

In step S2602, the color separation quantization unit 211 further executes second tone correction processing on the density value K1′ obtained via the first tone correction processing of step S804 for the pixel to be processed.

In step S2603, the color separation quantization unit 211 determines whether or not the pixel to be processed is a second end portion. In a case where, according to the determination result, the pixel to be processed is a second end portion, the processing advances to step S2604. In a case where the pixel to be processed is not a second end portion, the processing advances to step S813.

In step S2604, the color separation quantization unit 211 further executes second tone correction processing on the density value K2′ obtained via the first tone correction processing of step S807 for the pixel to be processed.

FIG. 13B is a diagram illustrating example settings for the second tone correction processing, with In corresponding to the density values K1′ and K2′ before processing and Out corresponding to the density values K1′ and K2′ after processing. Accordingly, since the density values of the end portion pixels can be decreased, the image analysis unit 210 can also downsample dots for a nozzle array used at a pixel determined to be one of the end portions.

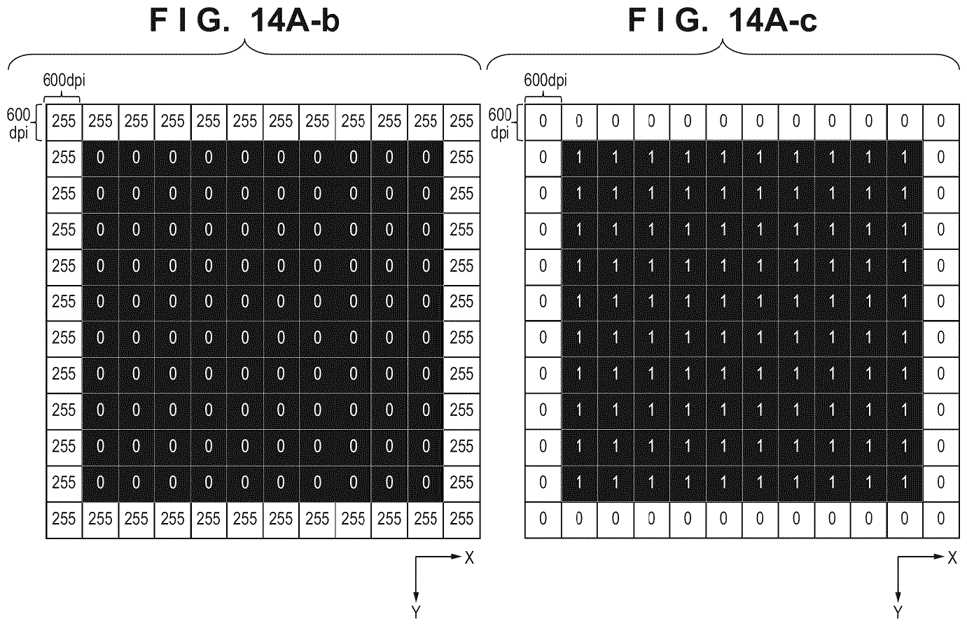

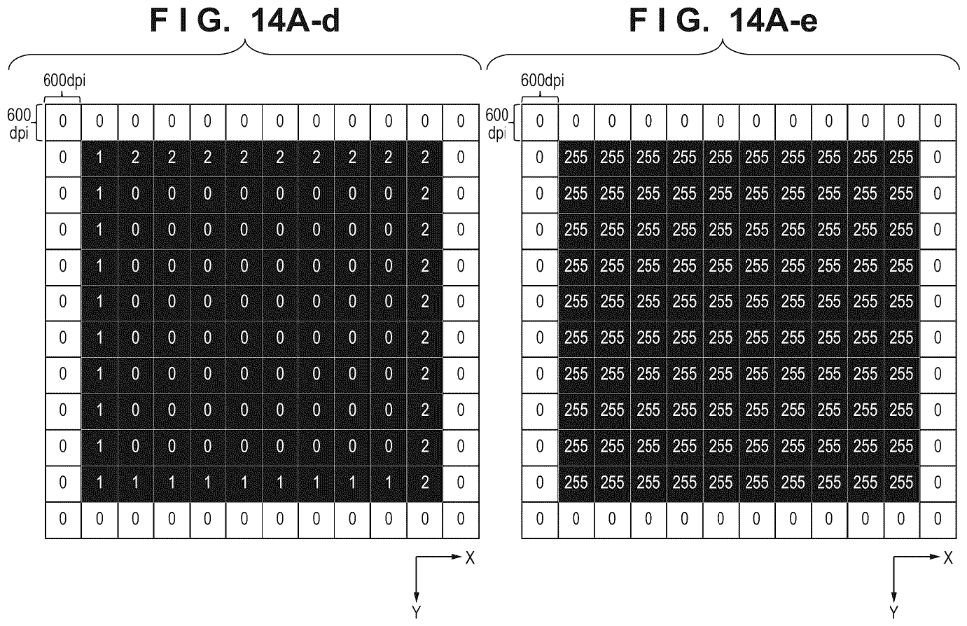

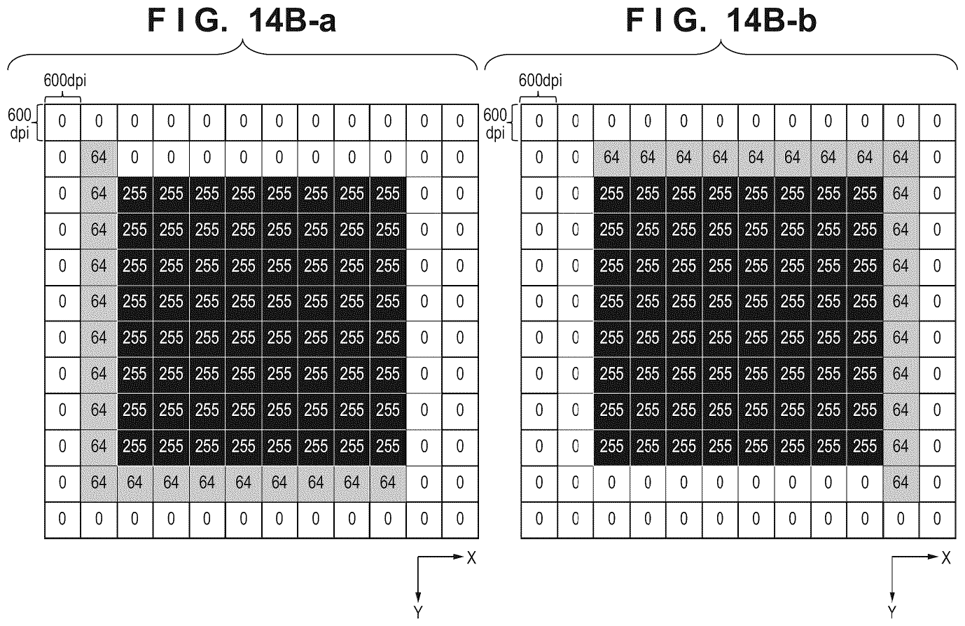

Next, an example of code image scanning accuracy enhancing edge processing according to the present embodiment will be described using FIGS. 14A-a to 14A-e, 14B-a to 14B-b, and 15A to 15E. FIG. 14A-a is a diagram illustrating an example of the bitmap image obtained via the decoding processing by the decoder unit 209 in step S302. In step S303, which end portion each pixel in the bitmap image corresponds to is detected by the image analysis unit 210. FIG. 14A-b is a diagram illustrating the data of the luminance Y after luminance conversion in step S401, and FIG. 14A-c is a diagram illustrating the binary values Bin which are the results of binarization of the data of the luminance Y using Th=50 in step S402. These are similar to FIGS. 10A-a, 10A-b, and 10A-c described above, and thus will not be described.

FIG. 14A-d is a diagram illustrating the result of edge determination on the binary values Bin described above. Here, “1” in FIG. 14A-d indicates a lower end portion and a left end portion and “2” indicates an upper end portion and a right end portion. The first end portion and the second end portion settings are different from the text readability enhancing edge processing described above.

Next, in step S304, the bitmap image obtained via the decoding processing in step S302 is subjected to color separation quantization processing by the color separation quantization unit 211 on the basis of the edge end portion detection result (end portion information) in step S303. FIG. 14A-e is a diagram illustrating the density value K1 and the density value K2 after the color separation processing in step S802 and is similar to FIG. 10A-e.

FIG. 14B-a is a diagram illustrating the density value K1′ after the tone correction processing of steps S803 to S805 and steps S2601 to S2602. Since the second end portions are determined as upper end portions and right end portions in step S803, pixels indicating “2” in FIG. 14A-d, that is, the upper end portion pixels and the right end portion pixels, have a density value of 0. On the other hand, after the first tone correction processing of step S804, the first end portions are determined as lower end portions and left end portions in step S2601, and the second tone correction processing is executed according to the settings illustrated in FIG. 13B in step S2602. In the present embodiment, settings are applied so that in a case where the density value K1 of In=255, the density value K1′ of Out=64.

FIG. 14B-b is a diagram illustrating the density values K2′ after the tone correction processing of steps S806 to S808 and steps S2603 to S2604. Since the first end portions are determined as a lower end portion and a left end portion in step S806, pixels indicating “1” in FIG. 14A-d, that is, the lower end portion pixels and the left end portion pixels, have a density value of 0. On the other hand, after the first tone correction processing of step S807, the second end portions are determined as upper end portions and right end portions in step S2603, and the second tone correction processing is executed according to the settings illustrated in FIG. 13B in step S2604. In the present embodiment, settings are applied so that in a case where the density value K2 of In=255, the density value K2′ of Out=64.

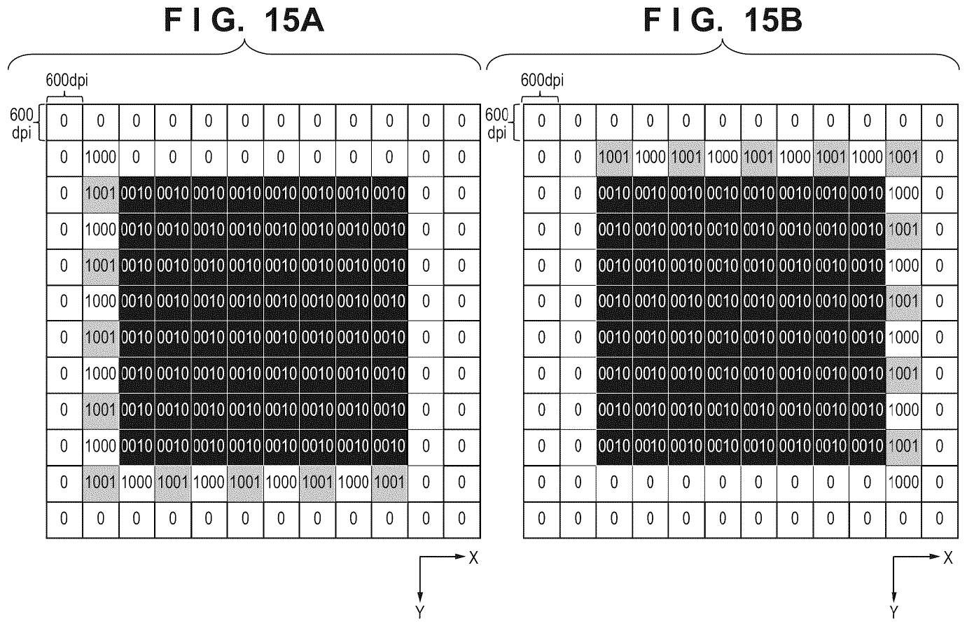

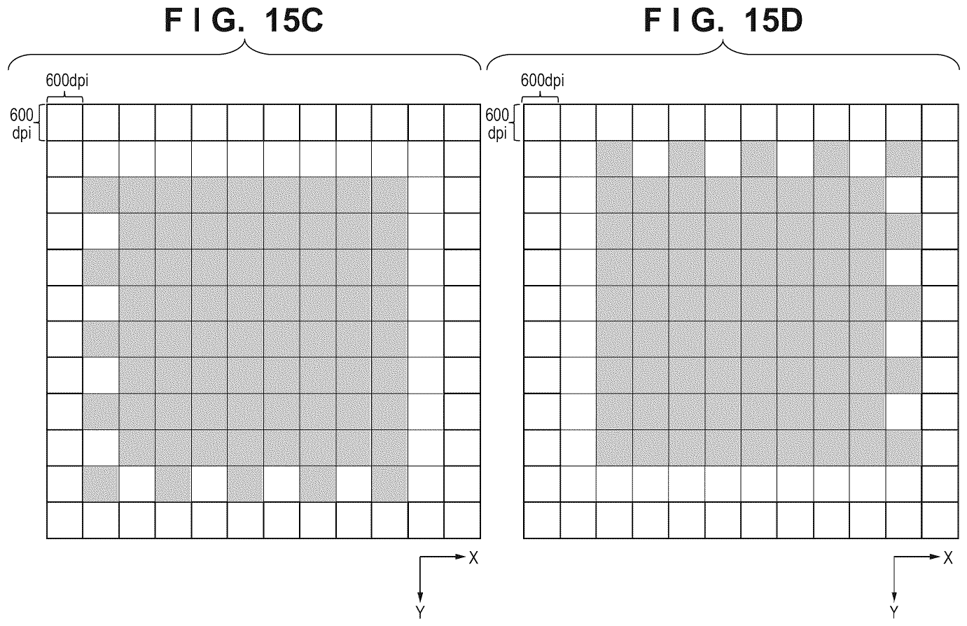

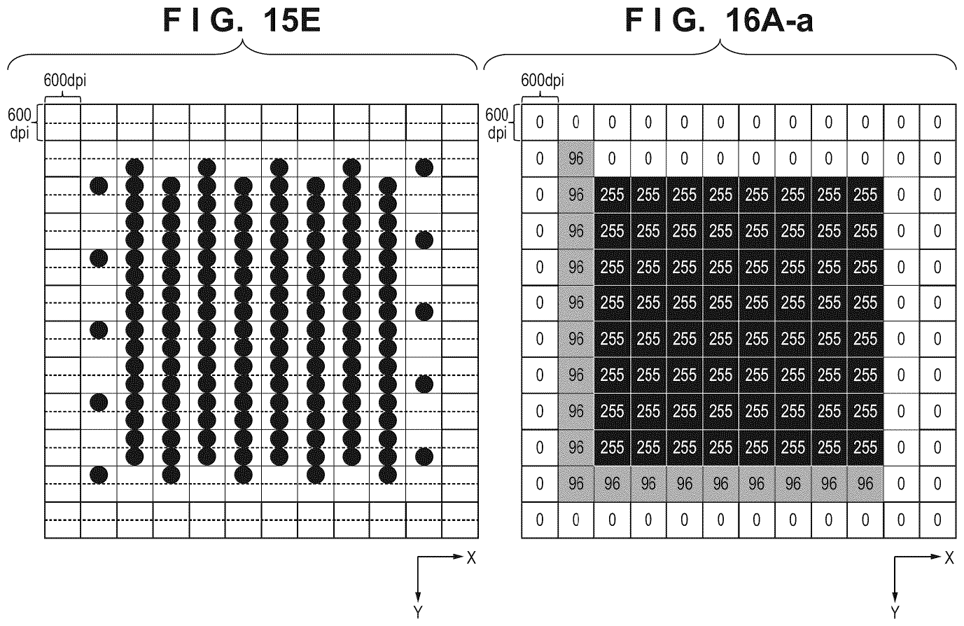

FIG. 15A is a diagram illustrating the quantization value K1″ obtained after the processing of steps S809 to S812, and FIG. 15B is a diagram illustrating the quantization value K2″ obtained after the processing of steps S813 to S816. In the example illustrated here, half of the density values 64 are quantized to “0000” and half to “0001” and the density values 255 are quantized to “0010” in the steps S809 and S813. Also, the definition of the first end portion and the second end portion in steps S810 and S814 are similar to that in steps S806 and S803. Thus, as illustrated in FIG. 15A, half of the pixels indicating “1” in FIG. 14A-d, that is, the quantization values of the lower end portion pixels and the left end portion pixels, are disposed as “1000” and half as “1001”, and the quantization value of the pixels indicating “0” in FIG. 14A-d is “0010”. On the other hand, as illustrated in FIG. 15B, half of the pixels indicating “2” in FIG. 14A-d, that is the quantization values of the upper end portion pixels and the right end portion pixels, are disposed as “1000” and half as “1001”, and the quantization value of the pixels indicating “0” in FIG. 14A-d is “0010”.

Next, in step S305, the bitmap image quantized in step S304 is subjected to index expansion processing by the nozzle separation unit 212. FIGS. 15C and 15D are each diagrams illustrating the nozzle data K1p and K2p after the index expansion processing of steps S817 and S818. FIG. 15E is a diagram illustrating the dot arrangement when the print head H performs printing at 600 dpi×1200 dpi on the basis of the nozzle data K1p and the nozzle data K2p. By comparing FIGS. 14A-b, 14A-d, and 15E, it can be found that, of the pixels with a luminance value of 0 in FIG. 14A-b, the pixels that are not the upper end portion, the lower end portion, the left end portion, and the right end portion in FIG. 14A-d have dots arranged in each region of the 600 dpi×1200 dpi of FIG. 15E. It can be found that, of the pixels with a luminance value of 0 in FIG. 14A-b, the pixels determined to be a lower end portion and a left end portion in FIG. 14A-d have a dot arranged only for upstream nozzles, that is, Ev nozzles, and the downsampling rate is set higher than in the text readability enhancing edge processing as in FIG. 15E. Also, it can be found that, of the pixels with a luminance value of 0 in FIG. 14A-b, the pixels determined to be an upper end portion and a right end portion in FIG. 14A-d have a dot arranged only for downstream nozzles, that is, Od nozzles, and the downsampling rate is set higher than in the text readability enhancing edge processing as in FIG. 15E.

As described above, in the code image scanning accuracy enhancing edge processing, compared with an image for edge detection, with an apparatus configuration configured to print dots at a high resolution in the Y direction, the lower end portion pixels and the left end portion pixels are determined as first end portions on the object side of an edge portion of an object in the image, and the upper end portion pixels and the right end portion pixels are determined as the second end portions. Then, by changing the arrangement of the dots according to the determination result, the dots of the end portions are downsampled. In the present embodiment, for the upper end portion pixels and the lower end portion pixels, by preferentially downsampling the dots of the region (hereinafter also referred to as an end portion side) closer to the outer side of the object, the size of the bars, cells, and spaces in the two-dimensional code image can be brought close to an ideal size for input even if there is ink bleeding.

In the example described above, black data is used in the processing of step S803 onward. However, in step S802, the density values of cyan, magenta, and yellow, that is, not black data, is also output. In the code image scanning accuracy enhancing edge processing, for cyan, magenta, and yellow also, the processing for the second tone correction processing of steps S2602 and S2604 is similar as that executed for black ink, with the caveat that the downsampling rate is optimally set for each. For example, the downsampling rate may be set lower than black according to a condition including the color ink having higher brightness and ink bleeding standing out less compared to black, the dot diameter of ink droplets, that is, the discharge amount, being set low taking into account the photo printing application, and the like.

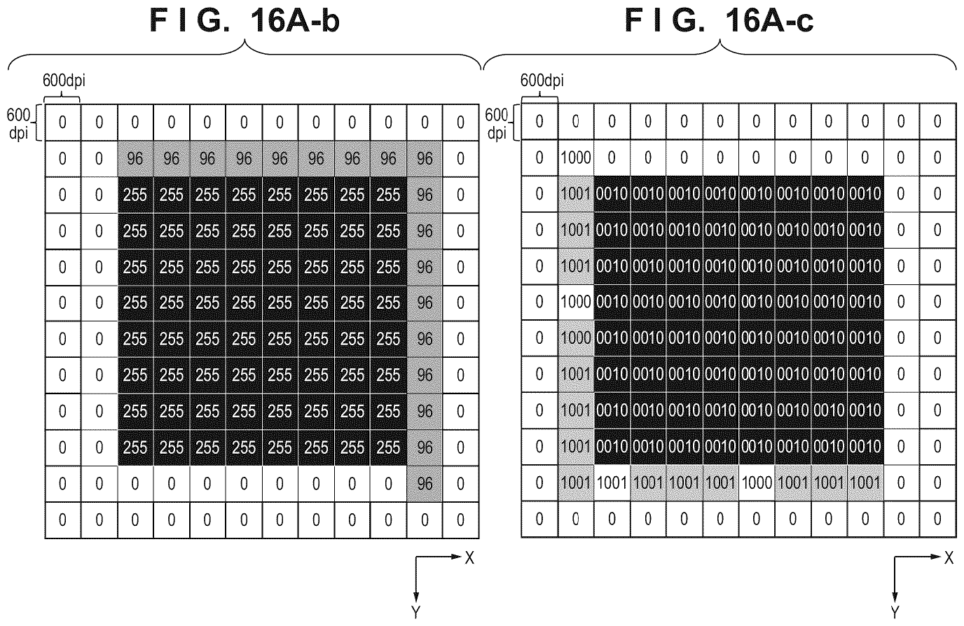

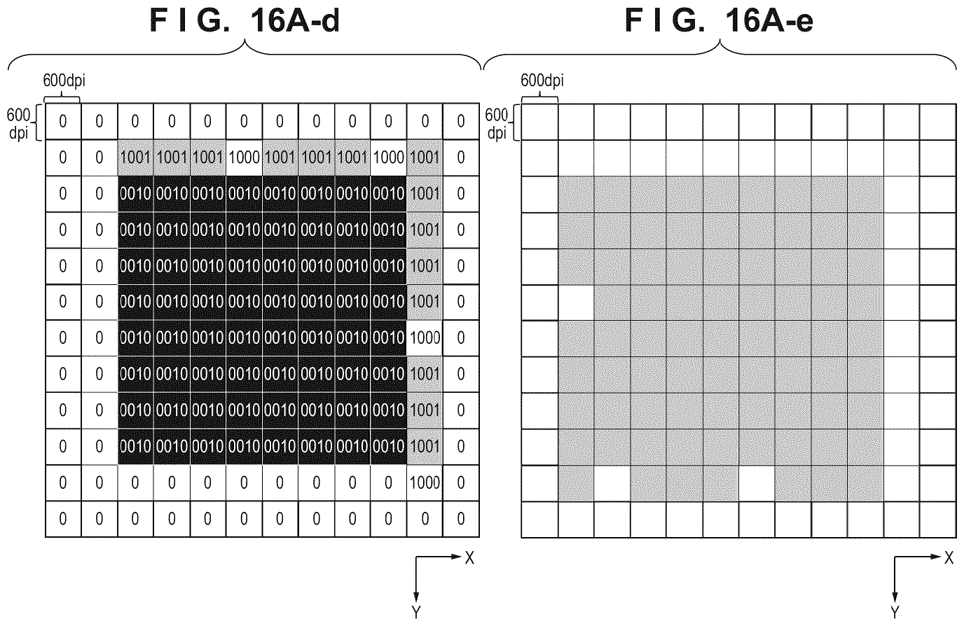

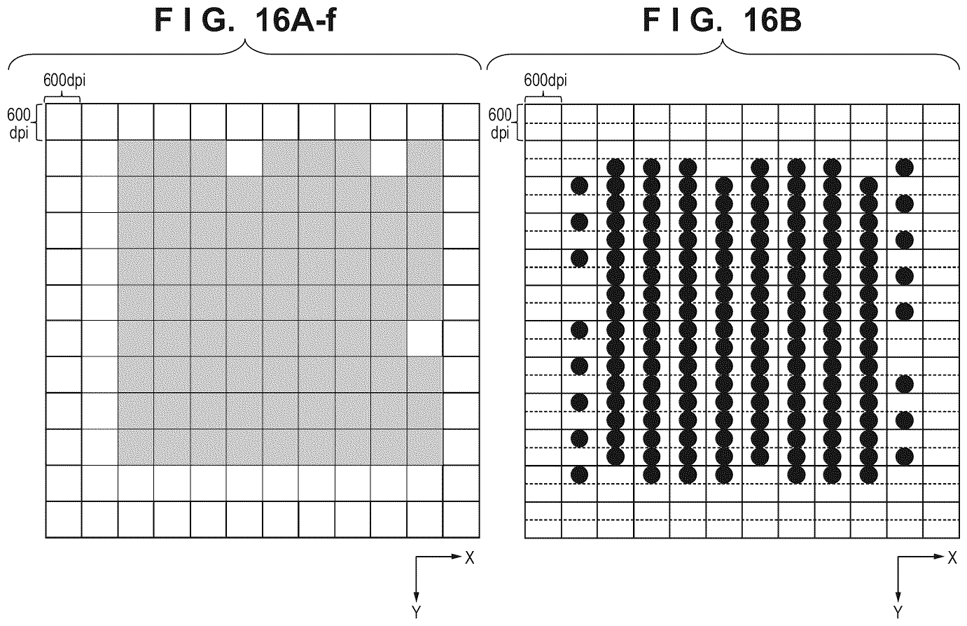

An example of setting different downsampling rates for cyan data and black data will now be described using FIGS. 16A-a to 16A-f and 16B. FIG. 16A-a is a diagram illustrating a density value C1′ after the processing of steps S803 to S805 and steps S2601 to S2602. As with black data, since the second end portions are determined as upper end portions and right end portions in step S803, pixels indicating “2” in FIG. 14A-d, that is, the upper end portion pixels and the right end portion pixels, have a density value of 0. On the other hand, after the first tone correction processing of step S804, the first end portions are determined as lower end portions and left end portions in step S2601, and the second tone correction processing is executed according to the settings illustrated in FIG. 13B in step S2602. For the cyan data, settings are applied so that in a case where the density value K1 of In=255, the density value K1′ of Out=96. In this manner, edge processing is executed at a lower downsampling rate than for black data.

FIG. 16A-b is a diagram illustrating density values C2′ after the processing of steps S806 to S808 and steps S2603 to S2604. As with black data, since the first end portions are determined as a lower end portion and a left end portion in step S806, pixels indicating “1” in FIG. 14A-d, that is, the lower end portion pixels and the left end portion pixels, have a density value of 0. On the other hand, after the first tone correction processing of step S807, the second end portions are determined as upper end portions and right end portions in step S2603, and the second tone correction processing is executed according to the settings illustrated in FIG. 13B in step S2604. For the cyan data, settings are applied so that in a case where the density value K2 of In=255, the density value K2′ of Out=96. In this manner, edge processing is executed at a lower downsampling rate than for black data.

FIG. 16A-c is a diagram illustrating a quantization value C1″ obtained after the processing of steps S809 to S812, and FIG. 16A-d is a diagram illustrating a quantization value C2″ obtained after the processing of steps S813 to S816. In the example illustrated here, the density values 96 are quantized to “0000” and “0001” at a ratio of approximately 1 to 4, and the density values 255 are quantized to “0010” in the steps S809 and S813. Also, the definition of the first end portion and the second end portion in steps S810 and S814 are similar to that in steps S806 and S803. Thus, as illustrated in FIG. 16A-c, the pixels indicating “1” in FIG. 14A-d, that is, the quantization values of the lower end portion pixels and the left end portion pixels, are disposed as “1000” and “1001” at a ratio of approximately 1 to 4, and the quantization value of the pixels indicating “0” in FIG. 14A-d is “0010”. On the other hand, as illustrated in FIG. 16A-d, the pixels indicating “2” in FIG. 14A-d, that is, the quantization values of the upper end portion pixels and the right end portion pixels, are disposed as “1000” and “1001” at a ratio of approximately 1 to 4, and the quantization value of the pixels indicating “0” in FIG. 14A-d is “0010”.

Next, in step S305, the bitmap image quantized in step S304 is subjected to index expansion processing by the nozzle separation unit 212. FIGS. 16A-e and 16A-f are each diagrams illustrating the nozzle data C1p and C2p after the index expansion processing of steps S817 and S818. FIG. 16B is a diagram illustrating the dot arrangement when the print head H performs printing at 600 dpi×1200 dpi on the basis of the nozzle data C1p and the nozzle data C2p. By comparing FIGS. 14A-b, 14A-d, and 16B, it can be found that, of the pixels with a luminance value of 0 in FIG. 14A-b, the pixels that are not the upper end portion, the lower end portion, the left end portion, and the right end portion in FIG. 14A-d have dots arranged in each region of the 600 dpi×1200 dpi. It can be found that, of the pixels with a luminance value of 0 in FIG. 14A-b, the pixels determined to be a lower end portion and a left end portion in FIG. 14A-d have a dot arranged only for upstream nozzles, that is, Ev nozzles, and the downsampling rate is set lower than for black data in FIG. 16B. Also, it can be found that, of the pixels with a luminance value of 0 in FIG. 14A-b, the pixels determined to be an upper end portion and a right end portion in FIG. 14A-d have a dot arranged only for downstream nozzles, that is, Od nozzles, and the downsampling rate is set lower than a lower downsampling rate than for black data in FIG. 16B. In a similar manner for magenta and yellow, an optimal downsampling rate for each is set and edge processing is executed.

Note that for an ink such as yellow that has sufficiently high brightness and that hardly stands out when the ink bleeds, for the upper end portion pixels and the lower end portion pixels, dots on the object end portion side may not be preferentially downsampled. For example, of the flow illustrated in FIG. 13A, end portions may not be detected in steps S803 and S806, and any end portions whether the first or second or not may be detected in steps S2601 and S2603. Then, in step S305, index expansion processing is executed on the bitmap image quantized in step S304 by the nozzle separation unit 212 using the dot arrangement pattern illustrated in FIGS. 12C and 12D. In this manner, dots can be downsampled at the set downsampling rate without taking into account a priority order for the upper end portion pixels and the lower end portion pixels. Also, for an ink such as yellow that has sufficiently high brightness and that hardly stands out when the ink bleeds, the downsampling rate may be set lower compared to other color ink such as magenta and cyan with relatively low brightness and the use amount of each end portion pixel may be increased. For example, in the second tone correction processing of steps S2602 and S2604, in a case where the In density value K1 of the yellow data=255, settings are applied so that the Out density value K1′=160. In this manner, edge processing can be executed at a lower downsampling rate than for cyan data. As described above for steps S402 and S403, in the case of performing edge pattern detection after binarization of the luminance value of each pixel, ink such as yellow with high brightness may be used at a significant amount for both Bin=1 pixels and Bin=0 pixels determined via Th of Condition Formula (1). In the case of an image for edge detection that is constituted of only pixels with luminance values near Th, the use amount of ink with a high brightness may be reduced by executing edge processing on only the pixels determined as an end portion of the edge. If the reduction amount is extremely large, it may be noticeable. However, by setting a low downsampling rate for the ink, the reduction amount can be reduced.

The type of ink bleeding of black, cyan, magenta, and yellow depends on the type of the print medium for printing and the number of passes when printing. Regarding this, the downsampling rate for each ink may be set in association with the type and quality of the print medium.

Examples of edge processing in an image forming apparatus installed with black, cyan, magenta, and yellow ink have been described. However, an image forming apparatus installed with a plurality of types of black ink for different functions and uses also exists. For example, such an image forming apparatus may be installed with a black ink with relatively high surface tension for mainly printing text and a black ink with relatively low surface tension mainly intended for photo printing on special paper. In this manner, in a case where a plurality of inks that can represent the same hue are present, for any of the inks, dots arranged in pixels of end portions of an object may be set to 0. Also, in a case where a plurality of black inks are not installed, process black can be formed by mixing cyan, magenta, and yellow. In a case where the object for edge processing is formed of black and process black, either black or process black arranged at pixels of end portions of an object may be set to 0.

In the embodiment of the code image scanning accuracy enhancing edge processing described herein, under the condition of being determined as the first end portion and the second end portion in step S803 in FIG. 13A, for the upper end portion pixels and the lower end portion pixels, dots on the object end portion side are preferentially downsampled. However, as long as an ideal size for input can be approached, no such limitation is intended.

### Switching Printing Mode

When printing is performed on a print medium of a type used mostly for printing text such as regular paper, a printing mode that uses text readability enhancing edge processing is applied, and when printing is performed on a print medium of a type used mostly for printing photos such as special paper, a printing mode that does not use edge processing is applied.

For example, when a user uses a user interface such as a keyboard or mouse included in the terminal apparatus 11 and operates the graphical user interface) GUI provided by a “driver of the image forming apparatus 10” installed in the terminal apparatus 11 to select the type and quality of the print medium, the driver sets the mode to a printing mode corresponding to the selected type and quality.

Also, when a user operates a user interface such as a control panel included in the image forming apparatus 10 and selects the type and quality of the print medium, the image forming apparatus 10 sets the mode to a printing mode corresponding to the selected type and quality.

Also, in a case where a user printing a two-dimensional code image, a dedicated code image printing mode, which is a dedicated printing mode that applies the code image scanning accuracy enhancing edge processing, is set. For example, when a user uses the user interface of the terminal apparatus 11 and operates the graphical user interface) GUI provided by a “driver of the image forming apparatus 10” installed in the terminal apparatus 11 to select a dedicated code image printing mode, the driver sets the mode to the dedicated code image printing mode.

Also, when a user operates the user interface of the image forming apparatus 10 and selects the dedicated code image printing mode, the image forming apparatus 10 sets the mode to the selected dedicated code image printing mode.

Also, the image forming apparatus 10 performs printing according to the set printing mode. Note that the printing mode setting method described above is merely an example, and the method is not limited to a specific setting method. For example, instead of the user setting (switching) the printing mode according to their goal, a step may be provided in the processing flow executed by the image forming apparatus 10 in which an object (text or two-dimensional code image) is detected from an input image data and edge processing suitable for the detected object is performed.

In this manner, if edge processing specialized for enhancing the scanning accuracy of a two-dimensional code image is applied to text, the line width of the text is too small, which may lead to a decrease in readability. However, in the present embodiment, by switching the optimal edge processing according to the object, technology can be provided that provides both enhancement of two-dimensional code image scanning accuracy and text readability.

### Second Embodiment

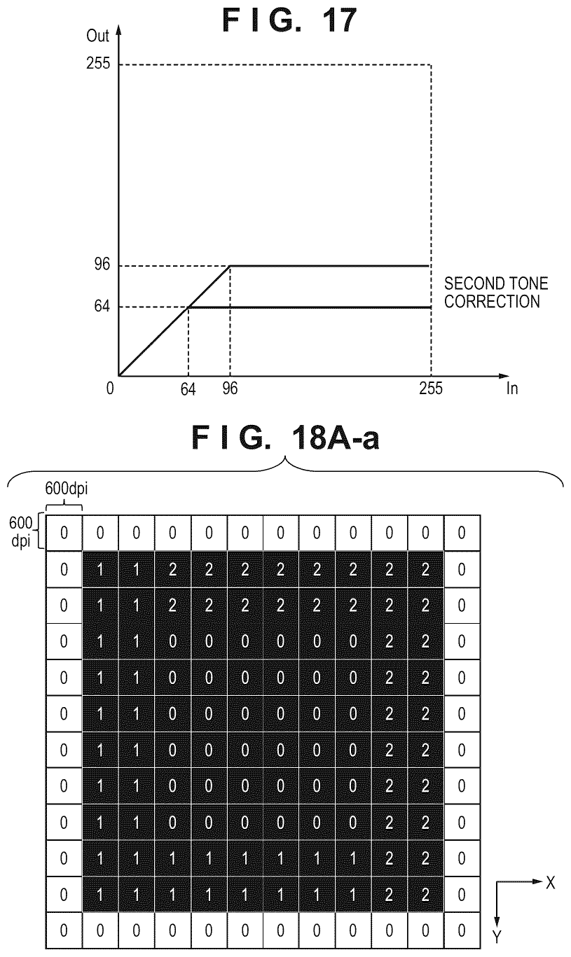

In the embodiments described below, including the present embodiment, the differences between the first embodiment will be described, and unless particularly mentioned, the other components are the same as in the first embodiment. In the first embodiment, relating to the second tone correction processing of the code image scanning accuracy enhancing edge processing, a setting example was described in which the post-processing density value Out is linear with respect to the pre-processing density value In as illustrated in FIG. 13B. However, in a case where the pre-processing density value In is low, since the original ink use amount is low, if dots of the pixels of the end portions are further downsampled, the linearity of the end portions may be greatly compromised, leading to a degradation of the scanning accuracy. Regarding this, by applying a setting value such as that illustrated in FIG. 17 in the second tone correction processing of steps S2602 and S2604 of FIG. 13A, in a case where the pre-processing density value In is low (the density value In is less than the threshold), the post-processing density value Out=In, that is downsampling of the dots of the end portion pixels in the second tone correction processing is not performed, an certain downsampling is performed on two-dimensional code image of midtones or more (density value In being equal to or greater than the threshold). For this second tone correction processing, setting values suitable for each ink are set. For example, for black, a setting value is applied so the pre-processing density value In=up to 64 and In=Out, and for cyan, magenta, and yellow, a setting value is applied so the pre-processing density value In=up to 96 and In=Out, and dot downsampling of the pixels of each end portion is performed.

### Third Embodiment

In the first embodiment and the second embodiment, an example in which edge processing is executed on one pixel portion of an end portion of an object is described. In the example according to the present embodiment described herein, regarding code image scanning accuracy enhancing edge processing, edge processing is executed on a plurality of pixels of an end portion of an object with the aim of reducing ink bleeding and bringing a printed material close to an ideal size for input.

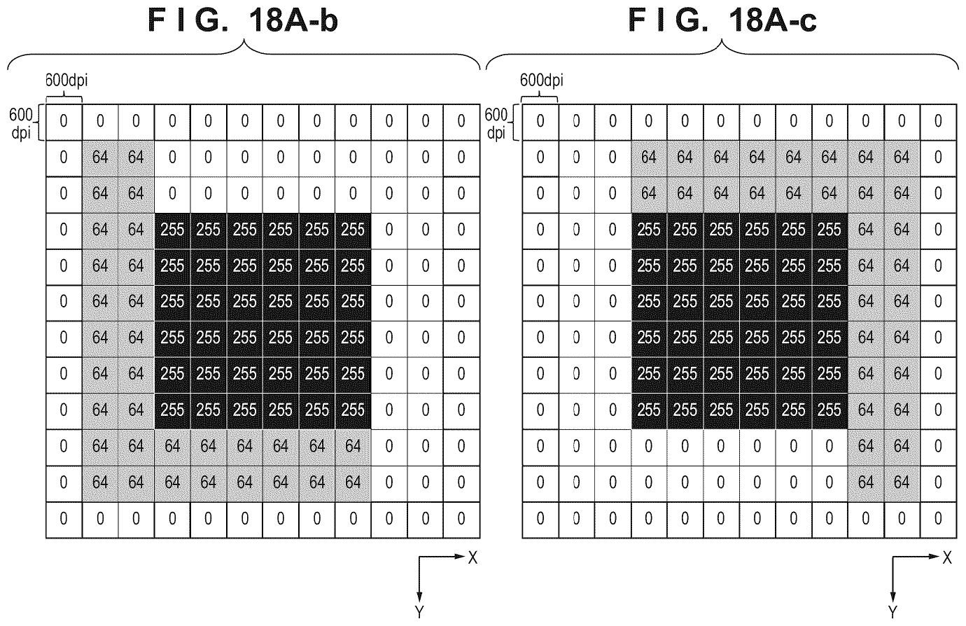

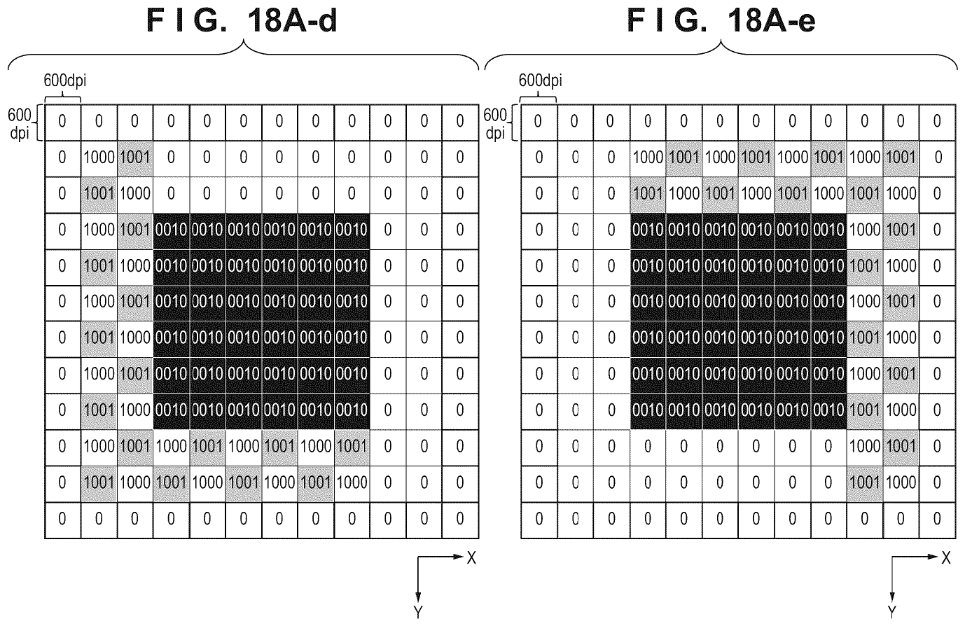

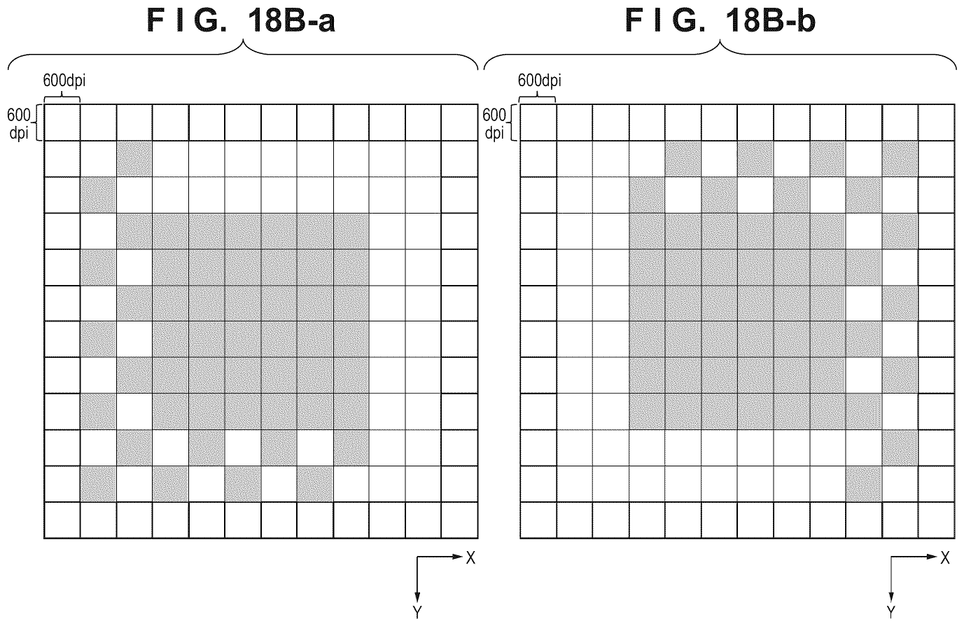

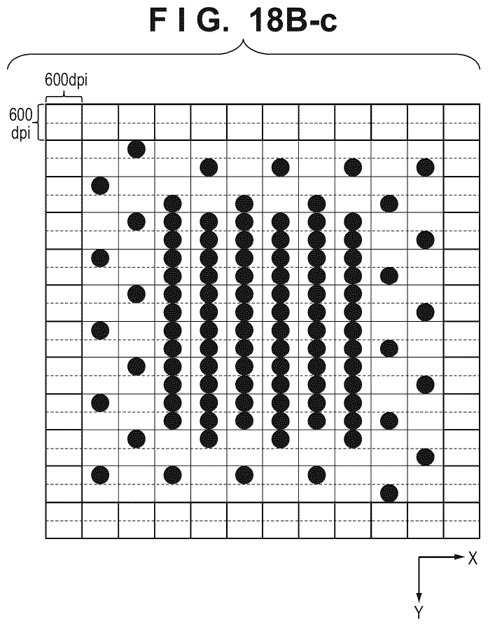

An example of edge processing performed on two pixel portions of an end portion of an object will be described below using FIGS. 18A-a to 18A-e and 18B-a to 18B-c. The processing of steps S401 and S402 in steps S301, S302, and S303 are similar to that of FIGS. 10A-a, 10A-b, and 10A-c described above and thus will not be described in detail.

FIG. 18A-a is a diagram illustrating the result of edge determination according to the present embodiment performed on the binary value Bin which is the result of binarization of the data of the luminance Y using Th=50 in step S402. “1” in FIG. 18A-a indicates a lower end portion and a left end portion, and “2” indicates an upper end portion and a right end portion. The number of pixels determined as an end portion pixel is different from the embodiments described above in that two pixels are determined.

Next, in step S304, the bitmap image obtained via the decoding processing in step S302 is subjected to color separation quantization processing by the color separation quantization unit 211 on the basis of the edge end portion detection result (end portion information) in step S303. The density value K1 and the density value K2 after the color separation processing in step S802 is similar to that in FIG. 10A-e.

FIG. 18A-b is a diagram illustrating the density value K1′ after the tone correction processing of steps S803 to S805 and steps S2601 to S2602. Since the second end portions are determined as upper end portions and right end portions of two pixels in step S803, pixels indicating “2” in FIG. 18A-a, that is, the upper end portion two pixels and the right end portion two pixels, have a density value of 0. On the other hand, after the first tone correction processing of step S804, the first end portions are determined as lower end portions and left end portions of two pixels in step S2601, and the second tone correction processing is executed according to settings in step S2602 so that the pre-processing density value In=up to 64 and In=Out as illustrated in FIG. 17. In other words, in a case where the density value K1 of In=255, the density value K1′ of Out=64.

FIG. 18A-c is a diagram illustrating the density values K2′ after the tone correction processing of steps S806 to S808 and steps S2603 to S2604. Since the first end portions are determined as lower end portions and left end portions of two pixels in step S806, pixels indicating “1” in FIG. 18A-a, that is, the lower end portion two pixels and the left end portion two pixels, have a density value of 0. On the other hand, after the first tone correction processing of step S807, the second end portions are determined as upper end portions and right end portions of two pixels in step S2603, and the second tone correction processing is executed according to settings in step S2604 so that the pre-processing density value In=up to 64 and In=Out as illustrated in FIG. 17. In other words, in a case where the density value K2 of In=255, the density value K2′ of Out=64.

FIG. 18A-d is a diagram illustrating the quantization value K1″ obtained after the processing of steps S809 to S812, and FIG. 18A-e is a diagram illustrating the quantization value K2″ obtained after the processing of steps S813 to S816. In the example illustrated here, half of the density values 64 are quantized to “0000” and half to “0001” and the density values 255 are quantized to “0010” in the steps S809 and S813. Also, the definition of the first end portion and the second end portion in steps S810 and S814 are similar to that in steps S806 and S803. Thus, as illustrated in FIG. 18A-d, half of the pixels indicating “1” in FIG. 18A-a, that is, the quantization values of the lower end portion and the left end portion two pixels, are disposed as “1000” and half as “1001”, and the pixels indicating “0” in FIG. 18A-a are “0010”. On the other hand, as illustrated in FIG. 18A-e, half of the pixels indicating “2” in FIG. 18A-a, that is the quantization data of the upper end portion and the right end portion two pixels, are disposed as “1000” and half as “1001”, and the pixels indicating “0” in FIG. 18A-a are “0010”.

Next, in step S305, the bitmap image quantized in step S304 is subjected to index expansion processing by the nozzle separation unit 212. FIGS. 18B-a and 18B-b are each diagrams illustrating the nozzle data K1p and K2p after the index expansion processing of steps S817 and S818. FIG. 18B-c is a diagram illustrating the dot arrangement when the print head H performs printing at 600 dpi×1200 dpi on the basis of the nozzle data K1p and K2p. It can be found that, of the pixels with a luminance value of 0 in FIG. 14A-b, the pixels that are not the upper end portion, the lower end portion, the left end portion, and the right end portion in FIG. 18A-a have dots arranged in each region of the 600 dpi×1200 dpi of FIG. 18B-c. It can be found that, of the pixels with a luminance value of 0 in FIG. 14A-b, the pixels determined to be a lower end portion and a left end portion in FIG. 18A-a have a dot arranged only for upstream nozzles, that is, Ev nozzles, and the end portion subjected to edge processing is set to two pixels as in FIG. 18B-c. Also, it can be found that, of the pixels with a luminance value of 0 in FIG. 14A-b, the pixels determined to be an upper end portion and a right end portion in FIG. 18A-a have a dot arranged only for downstream nozzles, that is, Od nozzles, and the end portion subjected to edge processing is set to two pixels as in FIG. 18B-c.

As described above, in the present embodiment, the lower end portions and the right end portions of two pixels are detected and determined as the first end portions on the object side of the edge portion of an object in an input image data and the upper end portions and the left end portions of two pixels are detected and determined as the second end portions. Then, by changing the arrangement of the dots according to the determination result, the dots of the end portions are downsampled. The region of the end portion two pixels is set as the edge processing target, and, for the upper end portion pixels and the lower end portion pixels, by preferentially downsampling the dots of the end portion region of the object, the size of the bars, cells, and spaces in the two-dimensional code image can be brought close to an ideal size for input even if there is ink bleeding.

In the example described above, black data is used in the processing of step S803 onward. However, in step S802, the density values of cyan, magenta, and yellow, that is, not black data, is also output. In the present embodiment also, for cyan, magenta, and yellow also, the processing for the second tone correction processing of steps S2602 and S2604 is similar as that executed for black ink, with the caveat that the downsampling rate is optimally set for each. For example, the downsampling rate may be set lower than black ink according to a condition including the color ink having higher brightness and ink bleeding standing out less compared to black, the dot diameter of ink droplets, that is, the discharge amount, being set low taking into account the photo printing application, and the like. In this case, after the first tone correction processing of steps S804 and S807, each of the end portions are determined in steps S2601 and S2603, and second tone correction processing is executed according to settings such that the pre-processing density value In=up to 96 and In=Out as illustrated in FIG. 17 in steps S2602 and S2604. In other words, in a case where the pre-processing density value In=255, the post-processing density value Out=96, and a downsampling rate lower than the downsampling rate of the end portion pixels of black described above is applied. Also, according to the present embodiment, for a similar reason to as in the first embodiment, for ink such as yellow that has a high brightness, the downsampling rate may be set lower compared to other color ink such as magenta and cyan with relatively low brightness and the use amount of each end portion pixel may be increased. In this case, in steps S2602 and S2604, the second tone correction processing is executed with a setting such that when the density value In≥160, In=Out, and when the density value In>160, Out=160 is applied for only the yellow data. In other words, in a case where the pre-processing density value In=255, the post-processing density value Out=160 for only the yellow data, and a downsampling rate lower than the downsampling rate of the end portion pixels of cyan and magenta is applied.

Note that in the case according to the present embodiment described above, edge processing is executed on two pixels of the end portion of an object. However, this is merely an example of a case of executing edge processing on pixels at least on the outermost portion and adjacent to the outermost portion in an edge region.

### Fourth Embodiment

In the example according to the embodiments described above, regarding code image scanning accuracy enhancing edge processing, for the pixels of upper end portions and pixels of lower end portions, dots of the object end portion side are preferentially downsampled to reduce ink bleeding and bring the line width of horizontal lines close to an ideal size for input.

In the example according to the present embodiment described here, by executing the processing (processing of step S501) according to the flowchart of FIG. 3C, dot position adjustment using discharge position adjustment values set by the print head control unit 213 is performed to bring the line width of vertical lines also close to an ideal size for input.

First, the processing of the discharge position adjustment according to the present embodiment will be described. The print head control unit 213 sets data for the Ev nozzles stored in the RAM 207 and discharge position adjustment values for the Ev nozzles for the Ev array 1121. Also, the print head control unit 213 sets data for the Od nozzles stored in the RAM 207 and discharge position adjustment values for the Od nozzles for the Od array 1122. The print head H prints an image on the print medium in the main scan direction on the basis of the data and discharge position adjustment values for the Ev nozzles and the data and discharge position adjustment values for the Od nozzles. Here, the discharge position adjustment values include correction values from reference values stored in the ROM 206 and reference values predetermined per printing mode and object. The discharge position adjustment values may further include values to be corrected from a reference value on the basis of a discharge position adjustment function discretionarily executed by a user. Also, a discharge position adjustment value may be relative position information with respect to the position of the print head H identified by the encoder strip of the image forming apparatus 10 or may be relative time information.

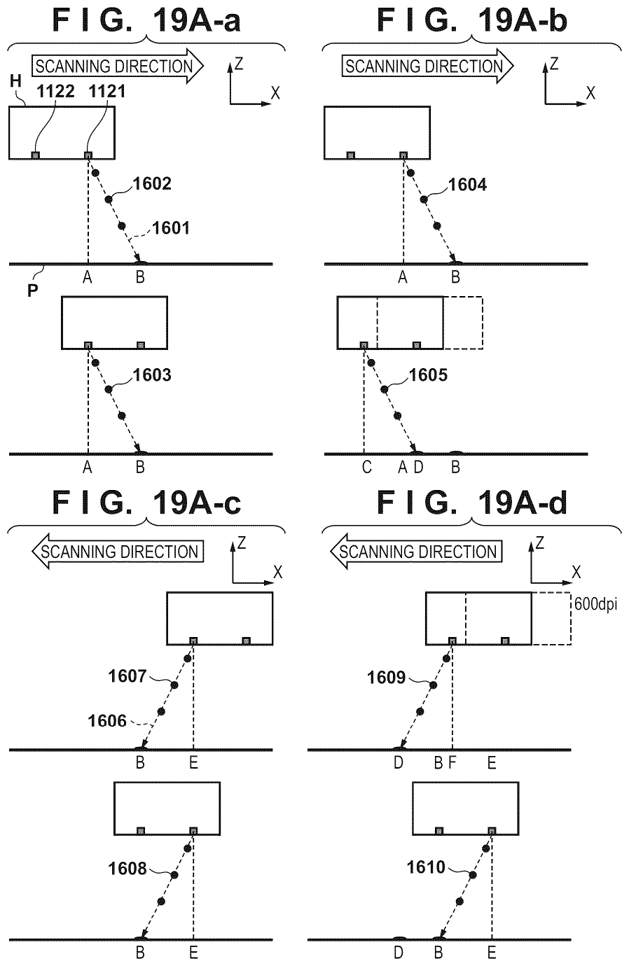

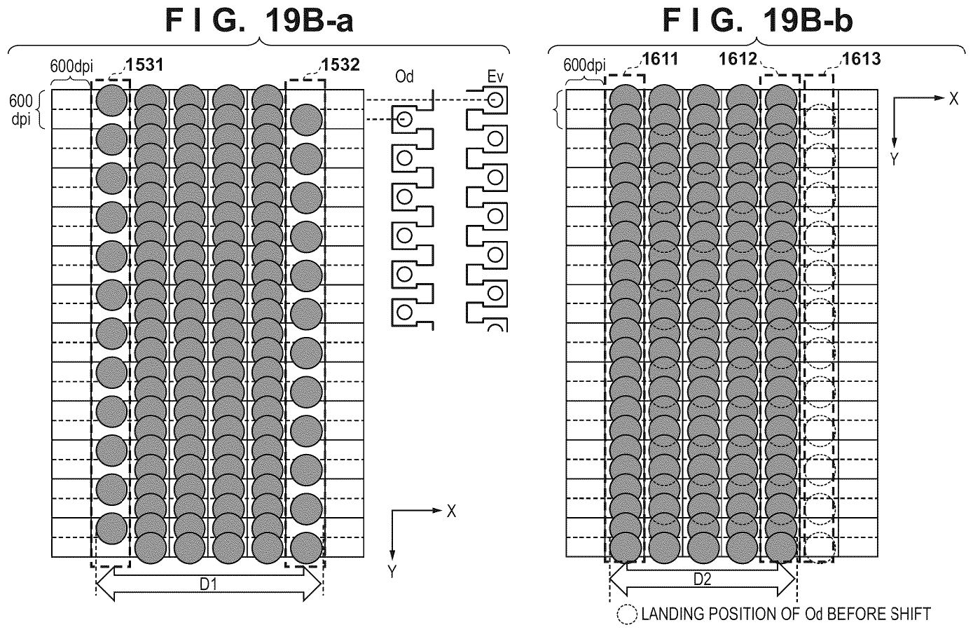

FIGS. 19A-a to 19A-d and 19B-a to 19B-b are diagrams illustrating an example of a case where dots are formed by Ev nozzles included in an Ev array and Od nozzles included in an Od array at a non-edge pixel at a point B on a print medium. For the sake of simplicity, ink droplets discharged from the Ev nozzles and ink droplets discharges from the Od nozzles by the print head H at the time of non-scanning are both orientated horizontal with the Z direction.

FIGS. 19A-a and 19A-c are diagrams of a case where the dot position is not adjusted or in other words a case where ink is discharged with respect to the point B with the Ev array 1121 and the Od array 1122 aims for the same place. As illustrated in FIG. 19A-a, an ink droplet 1602 discharged from a nozzle in the Ev array 1121 (the same applies for a nozzle in the Od array 1122) lands at the point B on the print medium P after passing through path 1601 via inertia in the scanning direction of the print head H. Thus, using the encoder strip and the discharge position adjustment value, the print head control unit 213 discharges ink from the Ev nozzles at the time that it is determined that the Ev array 1121 has reached a point A on the print medium P to make the ink droplet 1602 land at the point B. Thereafter, the print head control unit 213 discharges ink from the Od nozzles at the time that it is determined that the Od array 1122 has reached the point A on the print medium P to make an ink droplet 1603 land at the point B on the print medium P.

FIG. 19A-c is a diagram illustrating a case where the print head H performs a backward scan. Here, the ink droplet discharged from each nozzle lands on the print medium P after passing through path 1606 via inertia in the −X direction of the print head H. Thus, using the encoder strip and the discharge position adjustment value, the print head control unit 213 discharges ink from the Od nozzles at the time that it is determined that the Od array has reached a point E on the print medium P to make an ink droplet 1607 land at the point B on the print medium P. Thereafter, the print head control unit 213 discharges ink from the Ev nozzles at the time that it is determined that the Ev array has reached the point E on the print medium P to make an ink droplet 1608 land at the point B on the print medium P. When an image subjected to edge processing of end portion one pixel is printed in this state, the dot arrangement illustrated in FIG. 19B-a is formed regardless of the scanning direction of the print head H, and the landed dot width in the X direction at this time is D1. Note that as in known edge processing technology, even in a case where dots of the Ev nozzles and the Od nozzles are mixed at both the left end portion and the right end portion, the landed dot width in the X direction is approximately the same as D1.

FIGS. 19A-b and 19A-d are diagrams of a forward scan and a backward scan in the case of adjusting the dot position. In the case of a forward scan, using the encoder strip and the discharge position adjustment value, as illustrated in FIG. 19A-b, the print head control unit 213 discharges ink from the Ev nozzles at the time that it is determined that the Ev array has reached the point A on the print medium P to make an ink droplet 1604 land at the point B on the print medium P. Thereafter, using the encoder strip and the discharge position adjustment value, the print head control unit 213 discharges ink from the Od nozzles at the time that it is determined that the Od array has reached a point C on the print medium P offset in the −X direction from the point A. Accordingly, an ink droplet 1605 is made to land at a point D on the print medium P offset in the −X direction from the point B. Here, by setting the discharge position adjustment value to a higher resolution than the printing resolution, the distance in the X direction between the point B and the point D can be adjusted at a resolution less than the width of one pixel. In the case of a backward scan, using the encoder strip and the discharge position adjustment value, as illustrated in FIG. 19A-d, the print head control unit 213 discharges ink from the Od nozzles at the time that it is determined that the Od array has reached a point F on the print medium P offset in the −X direction from the point E. Accordingly, an ink droplet 1609 is made to land at the point D on the print medium P. Thereafter, the print head control unit 213 discharges ink from the Ev nozzles at the time that it is determined that the Ev array has reached the point E on the print medium P to make an ink droplet 1610 land at the point B on the print medium P. FIG. 19B-b illustrates a dot arrangement formed by forward scanning and backward scanning via the present adjustment and is similar to FIG. 19B-a in terms of the flight characteristics of the print head H in the present diagram. Compared to FIG. 19B-a, the dots formed by the Od nozzles are uniformly offset in the landing position in the −X direction, and a landed dot width D2 in the X direction is smaller than D1. In other words, since edge processing is executed with ink from the Ev nozzles for the left end portion pixels and ink from the Od nozzles for the right end portion pixels, the landing position of the Ev array and the Od array can be appropriately offset according to the level of the ink bleeding. This allows th line width of vertical lines to also be brought close to an ideal size for input.

Also, since the position offset amount can be set at less than a pixel width, D2 can also be adjusted at less than one pixel width. In other words, the width of a line formed on the print medium can be adjusted at less than one pixel width. Note that in the example illustrated in FIGS. 19A-a to 19A-d and 19B-a to 19B-b, discharge position adjustment is only performed on the Od array. However, no such limitation is intended, and the adjustment amount may be split in half between the Ev array and the Od array.

### Fifth Embodiment

In the first to fourth embodiments described above, downsampling processing is executed on dots arranged in pixels of an end portion of an object. However, depending on the level of ink bleeding, this may not be sufficient to bring the width close to an ideal size for input. Regarding this, in addition to downsampling dots corresponding to pixels of an end portion of an object, dots arranged in pixels of non-end portions of the object may be downsampled. In this manner, ink bleeding may be reduced across the entire image, and the region of downsampling dots of pixels of an end portion of an object can effectively function as a retarding basin.

Also, the image processing apparatus described in the first to fourth embodiment is a serial type. However, as long as the features and configurations are similar, the type is not limited thereto. For example, a line type print head may be used, or a configuration may be used in which serial types are vertically arranged.

Also, in the first to fourth embodiment described above, the image forming apparatus 10 is an inkjet printer. However, as long as the features and configurations are similar, the image forming apparatus 10 is not limited thereto. For example, the image forming apparatus 10 may be a laser printer that uses toner or a copy machine.

Also, in the first to fourth embodiment, a bitmap data area is described as the area inside the RAM 207. However, the device is not limited as long as it is a rewritable storage device. For example, a HDD or embedded multi media card (eMMC) may be provided separate from the RAM 207, and the entire data area or a portion of the data area may be disposed in the storage area of the HDD or eMMc.

Also, in the first to fourth embodiment described above, in the quantization of density values, all values are converted to 3 values. However, as long as the features and configurations are similar, no such limitation is intended. For example, the values may be converted to 2 or 4 or more values.

Also, in the first to fourth embodiment described above, it is assumed that the print head includes the Ev nozzles and the Od nozzles. However, as long as the features and configurations are similar, the type is not limited thereto. Of the first to fourth embodiments, as long as the nozzles are arranged at a higher resolution than the image for edge detection, the first to fourth embodiment can be applied to a case of printing at a higher resolution in the Y direction than the image for edge detection.

Also, in the first to fourth embodiment described above, image processing including edge processing is executed in the image forming apparatus 10. However, as long as the features and configurations are similar, the processing is not limited thereto. Specifically, a portion of or all of the image processing including edge processing may be executed by an apparatus separate to the image forming apparatus 10, and the image forming apparatus 10 may receive the processing result and execute the subsequent processing.

The numerical values; processing timing; processing order; processing; subjects of processing; configuration, obtaining method, transmission destination, transmission source, and storage place of data (information); and the like used in the embodiments described above are examples for facilitating a detailed description, and no such limitations are intended.

Also, a part or all of the embodiments described above may be combined as appropriate. Furthermore, a part or all of the embodiments described above may be selectively used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167827, filed Sep. 26, 2024, and Japanese Patent Application No. 2025-102663, filed Jun. 18, 2025 which are hereby incorporated by reference herein in their entirety.

What is claimed is:

1. An image processing apparatus comprising:
a printing unit configured to downsample and print a two-dimensional code image when a mode for two-dimensional code image printing different from a mode for text printing is set.

2. The image processing apparatus according to claim 1, wherein
when a mode for text printing is set, the printing unit downsamples and prints text, and when a mode for two-dimensional code image printing is set, the printing unit downsamples more than text printed in the mode for text printing and prints a two-dimensional code image.

3. The image processing apparatus according to claim 1, further comprising:
a print head including two or more nozzle arrays configured of the same color and offset by half a pitch from each other in a nozzle arrangement direction, and
when a mode for two-dimensional code image printing is set, the printing unit preferentially downsamples and prints dots on an end portion side for upper end pixels and lower end pixels on an inner side of an edge region of a two-dimensional code image.

4. The image processing apparatus according to claim 1, wherein
when a mode for two-dimensional code image printing is set, the printing unit executes edge processing on at an outermost portion and pixels adjacent to the outermost portion in an edge region.

5. The image processing apparatus according to claim 3, wherein
the print head moves relative to a print medium in a main scan direction,
when a mode for two-dimensional code image printing is set, the printing unit
for pixels on an inner side of a first edge region of a two-dimensional code image, downsamples dots of a first nozzle array in the print head, and for pixels on an inner side of a second edge region of the two-dimensional code image, downsamples dots of a second nozzle array in the print head, and
so that a distance in the main scan direction between a position of dots printed by the second nozzle array for pixels on an outermost side of the first edge region and a position of dots printed by the first nozzle array for non-edge pixels adjacent to an inner side of the first edge region is less than a width of the first edge region in the main scan direction, the position of the dots of the first nozzle array and the position of the dots of the second nozzle array are uniformly offset per pixel of a two-dimensional code image.

6. The image processing apparatus according to claim 3, wherein
when a mode for two-dimensional code image printing is set, the printing unit,
in a case where a density value for each ink color obtained by executing color separation processing on luminance values of an input image input as a print target is less than a threshold,
does not downsample dots of a second nozzle array in the print head for pixels on an inner side of a first edge region in a two-dimensional code image,
does not downsample dots of a first nozzle array in the print head for pixels on an inner side of a second edge region in a two-dimensional code image, and
in a case where a density value of the input image is equal to or greater than a threshold, sets the threshold to a density value of a pixel on an inner side of an edge region.

7. The image processing apparatus according to claim 1, wherein
in a case where an object to be printed is printed using a plurality of black inks in a mode for two-dimensional code image printing, the printing unit sets either black of pixels of an edge region of the object to 0.

8. The image processing apparatus according to claim 1, wherein
in a case where an object to be printed is printed using black ink and a plurality of color inks in a mode for two-dimensional code image printing, the printing unit sets either black ink of pixels of an edge region of the object or black expressed by a plurality of color inks to 0.

9. The image processing apparatus according to claim 1, further comprising:
a detecting unit configured to detect a two-dimensional code image from an input image input as a print target, wherein
when a mode for two-dimensional code image printing is set, the printing unit executes edge processing on a two-dimensional code image detected by the detecting unit.

10. The image processing apparatus according to claim 1, wherein
the printing unit
downsamples and prints dots of pixels on an inner side of an edge region of an object for black ink in a mode for text printing, and
downsamples and prints dots of pixels on an inner side of an edge region of an object for black ink and color ink in a mode for two-dimensional code image printing.

11. The image processing apparatus according to claim 10, further comprising:
a print head including two or more nozzle arrays configured of the same color and offset by half a pitch from each other in a nozzle arrangement direction, wherein
when a mode for two-dimensional code image printing is set, the printing unit preferentially downsamples and prints dots on an end portion side for upper end pixels and lower end pixels on an inner side of an edge region of an object of at least one color or more.

12. The image processing apparatus according to claim 10, wherein
when a mode for two-dimensional code image printing is set, the printing unit executes edge processing on at least an outermost portion and pixels adjacent to the outermost portion in an edge region.

13. The image processing apparatus according to claim 11, wherein
the print head moves relative to a print medium in a main scan direction,
when a mode for two-dimensional code image printing is set, the printing unit,
downsamples dots of a first nozzle array in the print head for pixels on an inner side of a first edge region of an object, and
downsamples dots of a second nozzle array in the print head for pixels on an inner side of a second edge region of an object, and
so that a distance in the main scan direction between a position of dots printed by the second nozzle array for pixels on an outermost side of the first edge region and a position of dots printed by the first nozzle array for non-edge pixels adjacent to an inner side of the first edge region is less than a width of the first edge region in the main scan direction, the position of the dots of the first nozzle array and the position of the dots of the second nozzle array are uniformly offset per pixel of an object.

14. The image processing apparatus according to claim 11, wherein
when a mode for two-dimensional code image printing is set, the printing unit,
in a case where a density value for each ink color obtained by executing color separation processing on luminance values of an input image input as a print target is less than a threshold,
does not downsample dots of a second nozzle array in the print head for pixels on an inner side of a first edge region of an object,
does not downsample dots of a first nozzle array in the print head for pixels on an inner side of a second edge region of an object, and
in a case where a density value of the input image is equal to or greater than a threshold, sets the threshold to a density value of a pixel on an inner side of an edge region.

15. The image processing apparatus according to claim 10, wherein
in a case where an object to be printed is printed using a plurality of black inks in a mode for two-dimensional code image printing, the printing unit sets either black of pixels of an edge region of the object to 0.

16. The image processing apparatus according to claim 10, wherein
in a case where an object to be printed is printed using black ink and a plurality of color inks in a mode for two-dimensional code image printing, the printing unit sets either black ink of pixels of an edge region of the object or black expressed by a plurality of color inks to 0.

17. The image processing apparatus according to claim 10, further comprising:
a detecting unit configured to detect a two-dimensional code image from an input image input as a print target, wherein
when a mode for two-dimensional code image printing is set, the printing unit executes edge processing on a two-dimensional code image detected by the detecting unit.

18. The image processing apparatus according to claim 10, wherein
in a case where color ink of pixels of the inner side of the edge region of the object is downsampled and printed in the mode for two-dimensional code image printing,
a maximum value of an ink amount provided to the pixels of a first color ink with a highest brightness from among the color ink is greater than a maximum value of an ink amount provided to the pixels of a second color ink with a lower brightness than the first color ink from among the color ink.

19. An image processing method performed by an image processing apparatus comprising:
downsampling and printing a two-dimensional code image when a mode for two-dimensional code image printing different from a mode for text printing is set.
